(19) United States
(12) Patent Application Publication
(10) Pub. No.: US 2026/0369107 A1
(43) Pub. Date: Nov. 19, 2026

(54) UNDERSTANDING COLLISIONS CAUSED BY OTHER VEHICLES IN A WAREHOUSE ENVIRONMENT USING THE ONBOARD IMU ON ROBOTIC INDUSTRIAL VEHICLES

(71) Applicant: ATLAS ROBOTICS AND AUTOMATION, INC., Pittsburgh, PA (US)

(72) Inventors: Çetin Alp Meriçli, Pittsburgh, PA (US); Tekin Alp Meriçli, Pittsburgh, PA (US)

(21) Appl. No.: 19/468,246

(22) Filed: Feb. 3, 2026

Related U.S. Application Data
(60) Provisional application No. 63/753,185, filed on Feb. 3, 2025.

(51) Int. Cl. G07C 5/00; G07C 5/04; G07C 5/08; G08G 7/02

(52) U.S. Cl. CPC G07C 5/008; G07C 5/04; G07C 5/085; G08G 7/02

(57) ABSTRACT

A collision detection system for robotic industrial vehicles uses onboard Inertial Measurement Unit (IMU) sensors to detect and characterize physical impacts when other vehicles strike the robot in warehouse environments. The system filters IMU data to identify acceleration anomalies characteristic of collisions and classifies collision causation using a three-tier approach (external, self_caused, or uncertain) by analyzing impact direction versus commanded trajectory direction and collision avoidance system state. Collision severity is assessed using peak G-force and velocity change metrics. The system captures comprehensive multi-modal sensor logs (IMU, LIDAR, camera, audio, robot state data) for all collision events, with uncertain classifications prioritized for offline review to determine definitive causation. Collision event records are transmitted to warehouse management systems for fleet-wide analytics including spatial heat maps and cause attribution, enabling data-driven safety improvements and operational optimization in mixed autonomous and human-operated vehicle environments.

### CROSS-REFERENCE TO RELATED APPLICATIONS

This application claims priority to U.S. Provisional Patent Application No. 63/753,185, filed Feb. 3, 2025, entitled “UNDERSTANDING COLLISIONS CAUSED BY OTHER VEHICLES IN A WAREHOUSE ENVIRONMENT USING THE ONBOARD IMU ON ROBOTIC INDUSTRIAL VEHICLES,” the entire contents of which are incorporated herein by reference.

### TECHNICAL FIELD

The present disclosure relates generally to autonomous and robotic industrial vehicles, and more particularly to systems, methods, and apparatus for detecting, analyzing, and understanding collision events caused by other vehicles (both autonomous and human-operated) striking the robotic vehicle in warehouse and industrial environments, using onboard Inertial Measurement Unit (IMU) sensors to directly measure physical impacts, classify collision severity based on shock and vibration characteristics, distinguish collision causes, and provide actionable safety and operational insights.

### BACKGROUND

In modern warehouse and industrial environments, autonomous mobile robots (AMRs), automated guided vehicles (AGVs), and robotic forklifts are increasingly deployed for material handling, palletizing, inventory management, and other logistics operations. These robotic systems often share operational spaces with human-operated vehicles such as manually-driven forklifts, pallet jacks, tuggers, and other industrial equipment. The mixed-traffic environment creates critical safety challenges, as collisions between vehicles can result in equipment damage, operational downtime, inventory loss, and potentially serious injuries to human workers.

Understanding the causes, frequency, and severity of collision events is critical for improving warehouse safety protocols, optimizing traffic management, reducing insurance costs, and enhancing overall operational efficiency. However, existing collision detection and analysis systems face several critical limitations that hinder comprehensive collision understanding.

### DESCRIPTION OF RELATED ART

Current approaches to collision detection in vehicles primarily rely on inertial sensors for detecting high-speed crashes in passenger vehicles. However, prior art systems do not address the unique challenges of detecting when other vehicles strike autonomous industrial robots in warehouse environments, nor do they teach distinguishing self-caused collisions from externally-caused collisions through control command correlation. Several patents demonstrate related use of accelerometers and IMUs:

U.S. Pat. No. 9,392,431 to Barfield et al. (Verizon, Jul. 12, 2016) describes “Automatic Vehicle Crash Detection Using Onboard Devices” using accelerometer data analysis for real-time crash detection with machine learning classification models. The system extracts features from three-axis accelerometer measurements to evaluate whether events represent genuine collisions versus false positives. However, this patent focuses exclusively on high-speed passenger vehicle crashes for airbag deployment and emergency response, does not address low-speed industrial vehicle collisions, and critically fails to distinguish between collisions caused by the vehicle's own navigation versus collisions caused by other vehicles striking the subject vehicle. Furthermore, it does not teach correlation of detected impacts with vehicle control commands to determine collision cause attribution, which is essential for accountability and safety improvement in mixed autonomous/human-operated warehouse environments.

U.S. Pat. No. 9,767,625 to Snyder et al. (Arity International, Sep. 19, 2017) describes “Automatic Crash Detection” using accelerometer data from mobile devices by analyzing quantity and magnitude of acceleration events to distinguish crashes from non-crash events like hard braking. While demonstrating threshold-based acceleration analysis for crash detection, this approach provides only binary crash/no-crash classification without collision severity quantification or cause attribution. Critically, it does not teach analysis of correlation between detected acceleration anomalies and vehicle control commands to determine whether the collision resulted from the subject vehicle's actions or from being struck by another vehicle; a fundamental distinction required for effective safety management in warehouse operations where autonomous robots operate alongside human-operated vehicles.

U.S. Pat. No. 8,725,346 to Xu et al. (Hong Kong Productivity Council, May 13, 2014) describes a “Collision Severity Determination System and Method” using multiple accelerometer-based subsystems to classify collision severity levels including rollover, airbag activation, and sudden slowdowns. This demonstrates multi-level severity assessment for automotive restraint system deployment but does not address warehouse-specific collision challenges such as low-speed impacts, pallet/floor operational vibrations, or mixed autonomous/manual vehicle traffic. Most importantly, it does not provide any method for differentiating between collisions caused by the subject vehicle's autonomous navigation errors versus collisions caused by external vehicles striking the robot, limiting its utility for root cause analysis and liability determination.

EP 4,436,840 to Nag et al. (Netradyne Inc., Oct. 2, 2024) describes “Systems and Methods for Collision Detection and Classification” using IMUs and machine learning to distinguish between actual collision events and non-collision events like speed bumps or rough roads. The system processes inertial sensor data with wavelet transforms and AI classifiers to reduce false positives in outdoor driving scenarios. However, this patent focuses on automotive applications and distinguishes collisions from road anomalies, not self-caused from externally-caused collisions. It does not teach correlation of IMU signatures with autonomous control commands to determine collision cause attribution, nor does it address warehouse industrial vehicle environments with their unique operational patterns (frequent starting/stopping, pallet handling, mixed traffic).

U.S. Pat. No. 12,148,301 to Ellis et al. (Geotab Inc., 2024) describes “Methods for Characterizing a Low-Impact Vehicle Collision Using High-Rate Acceleration Data” by analyzing acceleration data captured at 80-120 Hz combined with GPS and speed information. The system distinguishes low-impact collisions from false positives by evaluating multiple contextual factors including speed, location, and acceleration patterns. While relevant to low-speed collision detection, this patent focuses on characterizing collisions that occur during vehicle operation but does not teach methods for determining collision cause attribution; specifically, whether the collision resulted from the subject vehicle striking an obstacle or from another vehicle striking the subject vehicle. Without correlation analysis between detected impacts and vehicle control commands, this approach cannot support the accountability and safety improvement requirements of autonomous warehouse operations.

### SUMMARY

Recognition of Problems with Existing Approaches

While the prior art cited above demonstrates various approaches to collision detection using inertial sensors, these systems share several critical deficiencies that limit their applicability to autonomous industrial vehicles operating in warehouse environments where understanding collision cause and accountability is essential:

No Collision Cause Attribution: All cited prior art systems (Barfield, Snyder, Xu, Nag, Ellis) detect or classify collision events but fundamentally fail to determine whether the collision resulted from the subject vehicle's own navigation errors (robot striking an obstacle) versus being struck by another vehicle (external vehicle colliding with the robot). This distinction is critical for warehouse safety management, liability determination, and targeted operational improvements, yet none of the cited references teach methods for distinguishing self-caused from externally-caused collisions.

No Control Command Correlation: None of the cited prior art teaches correlating detected IMU acceleration anomalies with the vehicle's autonomous control commands (throttle, steering, braking) at the time of impact. Without analyzing whether the vehicle was executing aggressive maneuvers (suggesting self-caused collision) versus stationary or steady-state operation (suggesting externally-caused collision), these systems cannot attribute collision responsibility; a fundamental requirement for improving autonomous navigation algorithms versus improving traffic management protocols.

Passenger Vehicle Focus, Not Industrial Vehicles: The cited references (Barfield, Snyder, Xu, Ellis) primarily address high-speed passenger vehicle crashes for airbag deployment and emergency response, not the low-speed (1-3 m/s), high-frequency collision scenarios characteristic of warehouse industrial vehicles. These systems are optimized for detecting rare, high-severity crashes rather than frequent, low-to-moderate impact events that occur in dense warehouse traffic environments.

No Mixed Autonomy Environment Considerations: None of the cited prior art addresses the unique challenge of autonomous robots operating alongside human-operated vehicles with unpredictable behavior patterns. Understanding whether collisions are caused by limitations in the robot's autonomous navigation (which can be algorithmically improved) versus erratic behavior of human-operated vehicles (which requires traffic management interventions) is essential for effective safety improvement but is not taught by any cited reference.

No Horizontal vs. Vertical Acceleration Differentiation: Basic IMU-based approaches (Barfield, Snyder, Xu, Nag, Ellis) do not teach prioritizing horizontal plane accelerations (X-Y axes) over vertical axis accelerations (Z-axis) to reduce false positives from floor surface irregularities. In warehouse environments with imperfect floor conditions (cracks, expansion joints, ramps), vertical vibrations from floor anomalies can exceed 2-5 m/s² without any collision occurring. Collisions from other vehicles striking the robot produce primarily horizontal impacts on the X-Y plane, yet none of the cited references teach differential treatment of acceleration axes to distinguish genuine lateral collisions from routine floor-induced vertical vibrations.

Classification Without Root Cause Analysis: While some cited references (Xu, Nag) provide collision severity classification (minor, moderate, severe), they do not provide root cause analysis explaining why the collision occurred. Severity classification alone is insufficient for operational improvement; warehouse operators need to understand whether collisions result from autonomous navigation failures, human operator errors, inadequate traffic protocols, or environmental factors to implement effective corrective measures.

### Specific Industry Challenges

Warehouse and industrial environments present unique collision detection challenges:

Mixed Autonomy: Autonomous robots must operate safely alongside human-operated vehicles with unpredictable behavior patterns.

High Traffic Density: Busy warehouses may have dozens of vehicles (autonomous and manual) operating simultaneously in shared aisles and intersections.

Varied Vehicle Types: Forklifts, pallet jacks, reach trucks, order pickers, tuggers, and other equipment have different sizes, speeds, and handling characteristics.

Complex Operational Patterns: Frequent starting, stopping, turning, and load handling create high baseline vibration and acceleration levels that complicate collision detection.

Accountability and Liability: Determining whether collisions were caused by autonomous vehicle errors or human operator errors is critical for safety improvement and liability assessment.

Continuous Operation Requirements: 24/7 warehouse operations require robust, maintenance-free collision detection that does not degrade over time.

### Need for Improvement

There is a critical need in the warehouse and industrial vehicle industry for an improved collision detection and analysis system that:

Directly measures physical impacts when other vehicles strike the robot, using shock and vibration sensing rather than visual inference

Detects and characterizes actual contact forces, impact magnitude, and collision dynamics regardless of lighting conditions, occlusions, or environmental factors

Operates using existing onboard hardware to minimize cost and complexity

Distinguishes actual collisions from routine operational vibrations and impacts

Classifies collision severity based on measured shock characteristics including peak acceleration, velocity change, and impact duration

Differentiates between collisions caused by the robot versus collisions caused by other vehicles striking the robot

Generates detailed collision event data for safety analysis and operational improvement

Integrates with warehouse management systems for comprehensive fleet-wide insights

The present disclosure addresses these needs through innovative use of onboard Inertial Measurement Unit (IMU) sensors already present in robotic industrial vehicles for localization and navigation.

The present disclosure provides systems, methods, and apparatus for detecting, analyzing, and understanding collision events caused by other vehicles striking robotic industrial vehicles using onboard Inertial Measurement Unit (IMU) sensors. The disclosed systems leverage IMU data-including linear acceleration and angular velocity measurements—to directly measure physical impacts through shock and vibration sensing, enabling detection and characterization of collision events from other vehicles (both autonomous robotic vehicles and human-operated vehicles) that cannot be directly measured using vision-based perception systems. The IMU-based approach provides direct physical measurement of actual contact forces, impact magnitude, and collision dynamics when another vehicle strikes the robot.

In one embodiment, a collision detection and analysis system for a robotic industrial vehicle comprises: an Inertial Measurement Unit (IMU) mounted on the vehicle and comprising at least one accelerometer and at least one gyroscope generating continuous measurements of linear acceleration and angular velocity; one or more processors receiving IMU data from the IMU and executing collision detection software; and wherein the collision detection software is configured to: filter the IMU data to remove operational noise while preserving collision signatures; detect collision events based on analysis of filtered acceleration and angular velocity patterns; classify detected collisions based on characteristics including magnitude, direction, duration, and relationship to vehicle control inputs; and generate collision event reports including severity assessment and likely collision cause.

In another embodiment, the system distinguishes collision causes using a three-tier classification approach by analyzing the relationship between impact direction (from detected acceleration anomalies), commanded navigation trajectory direction, and collision avoidance system state. The system classifies collisions as: (1) external when impact direction is inconsistent with commanded trajectory direction or the robot was stationary, (2) self_caused when impact direction is consistent with commanded trajectory direction and no collision avoidance was active, or (3) uncertain when impact direction is consistent with commanded trajectory direction but collision avoidance was active at time of impact. For all collision events regardless of classification, the system triggers capture of comprehensive multi-modal sensor logs (IMU, LIDAR, camera, audio, robot state data) providing forensic-quality documentation. Uncertain classifications are prioritized for immediate offline analysis to determine definitive causation based on perception system detections, tracked vehicle trajectories, and temporal event sequences, while high-confidence external and self_caused classifications have optional offline review for validation purposes. Each classification includes a confidence score indicating the certainty of the assessment.

In another embodiment, collision severity is assessed using multiple metrics including: peak acceleration magnitude (G-forces), velocity change (delta-V), angular velocity change, impact duration, and frequency content of the acceleration signal. Collisions are classified into severity categories (e.g., minor, moderate, severe) based on these metrics, with responses scaled to severity level triggered for each category.

In another embodiment, the system employs a hybrid machine learning approach that continuously evolves over the deployment lifecycle as the fleet scales. Initially, anomaly detection models are trained on IMU data from normal operational events (loading, unloading, floor transitions, turns, etc.) to learn baseline operational patterns, enabling collision detection as deviations from normal operation without requiring labeled collision examples. As the fleet accumulates collision events over time, comprehensive collision event logs with verified causation labels (from offline multi-modal analysis) create a growing labeled dataset. This labeled data enables introducing supervised learning models that are trained on confirmed collision event signatures (labeled by type, cause, and severity) and normal operational patterns. Rather than replacing the anomaly detection model, the system employs an ensemble approach where both anomaly detection and supervised learning models operate in parallel, with outputs combined using weighted fusion where weights are dynamically adjusted based on the quantity and quality of accumulated labeled collision data. Initially, anomaly detection receives higher weight (e.g., 0.9 anomaly, 0.1 supervised when few labeled examples exist), and as labeled collision data accumulates from increasing fleet size and longer deployment duration, supervised learning weight progressively increases (e.g., 0.3 anomaly, 0.7 supervised with extensive labeled data), while retaining anomaly detection for detecting novel collision types not yet represented in the training data. The system supports continual learning where both models are periodically retrained on accumulated fleet-wide collision data, enabling progressive improvement in collision detection and classification performance that scales with both fleet size and deployment duration.

In another embodiment, collision event data is logged with comprehensive context including: timestamp, vehicle position (from localization system), vehicle state (velocity, heading, load status, operational mode), IMU data surrounding the event (e.g., +5 seconds of high-rate data), collision characterization (magnitude, direction, duration, severity classification), and collision cause classification (self_caused, external, or uncertain) with associated confidence score. This data enables detailed post-event analysis.

In another embodiment, the system integrates with the warehouse management system (WMS) or fleet management system to provide fleet-wide collision analytics including: collision frequency by location (identifying high-risk zones), collision frequency by time of day or operational condition, collision cause attribution (autonomous navigation errors vs. human operator errors vs. environmental factors), trends over time, and recommendations for safety improvements.

In another embodiment, real-time alerts are generated when collisions are detected, including immediate notification to operators, vehicle supervisors, or safety personnel based on collision severity. High-severity collisions may trigger automatic safety responses such as vehicle stop, inspection requirement, or operational area restriction.

In another embodiment, the IMU-based collision detection system operates in parallel with and complements existing collision avoidance systems. External sensors (cameras, LIDAR, etc.) focus on preventing collisions caused by the robot, while the IMU system detects all collision events regardless of cause, providing comprehensive safety coverage.

In another embodiment, multiple IMU sensors are positioned at different locations on the vehicle to improve collision localization. By comparing timing and magnitude of acceleration signals at different IMU positions, the system can estimate the impact location on the vehicle, useful for identifying vulnerable areas and directing maintenance.

The disclosed systems provide numerous advantages over prior art:

Direct Physical Impact Measurement: IMU sensors directly measure shock, vibration, and acceleration when other vehicles (both autonomous and human-operated) strike the robot, providing quantitative impact data that cannot be obtained through visual inference from cameras or LIDAR. This enables precise collision severity classification based on actual contact forces.

Complementary to Collision Avoidance Systems: While external perception systems prevent robot-caused collisions, IMU-based detection identifies when other vehicles strike the robot, providing comprehensive safety coverage across both collision scenarios.

Environmental Robustness: IMU operation is unaffected by lighting, weather, dust, occlusions, or other environmental factors that can degrade visual sensor performance.

Cost Effectiveness: Leverages existing IMU hardware already installed for navigation and localization, requiring only software additions.

Collision Cause Attribution: Distinguishes collisions caused by robot navigation errors from those caused by other vehicles striking the robot, critical for accountability, liability assessment, and safety improvement.

Rich Event Characterization: Provides detailed collision dynamics data unavailable from contact sensors or external perception systems.

Operational Insights: Fleet-wide collision analytics identify systemic safety issues, high-risk locations, and opportunities for operational improvement.

24/7 Reliability: Solid-state IMU sensors provide continuous, maintenance-free operation throughout vehicle lifecycle.

These and other features, aspects, and advantages of the present disclosure will become better understood with reference to the following description and appended claims.

### BRIEF DESCRIPTION OF THE DRAWINGS

FIG. 1 depicts a robotic forklift system architecture with collision detection capabilities.

FIG. 2 depicts a flowchart of a method for collision detection and analysis.

FIG. 3 depicts a collision-triggered multi-modal sensor logging system with configurable time windows and data capture from multiple sensor streams for post-processing analysis.

FIG. 4 depicts a hybrid evolutionary machine learning architecture for collision detection.

### DETAILED DESCRIPTION OF PREFERRED EMBODIMENTS

The following detailed description presents various embodiments of systems and methods for collision detection and analysis in robotic industrial vehicles using onboard IMU sensors. While specific implementations are described, these should be understood as exemplary rather than limiting.

### I. System Architecture and Components

### A. Overall System Configuration

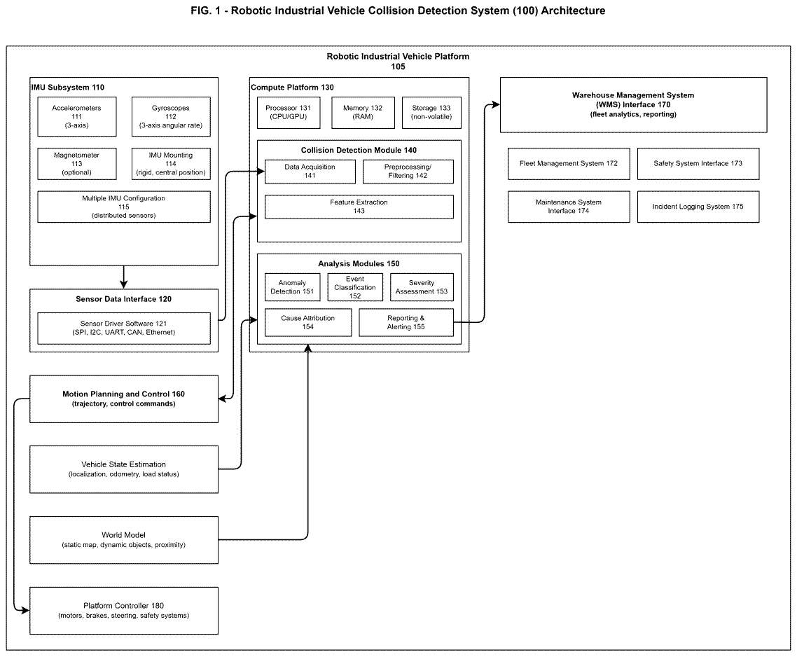

Referring to FIG. 1, a robotic industrial vehicle collision detection system (100) according to one embodiment comprises several integrated subsystems:

### Robotic Industrial Vehicle Platform (105):

The disclosure is applicable to various types of robotic industrial vehicles including:—Autonomous forklifts (counterbalance, reach trucks, order pickers)—Robotic pallet jacks and pallet trucks-Automated guided vehicles (AGVs)—Autonomous mobile robots (AMRs) for material transport-Tuggers and towing vehicles—Other warehouse mobile equipment

While examples herein often reference forklifts, the principles apply broadly to any robotic vehicle operating in industrial environments.

### Inertial Measurement Unit (IMU) (110):

The IMU subsystem comprises one or more inertial sensors measuring vehicle motion:

Accelerometers (111): Measure linear acceleration in three orthogonal axes (X, Y, Z). In various embodiments, accelerometers may have ranges such as +2 g to +16 g (where g=9.8 m/s²), resolutions such as 0.001 g to 0.01 g, and sample rates such as 100 Hz to 1000 Hz. Various accelerometer technologies may be used including MEMS (Micro-Electro-Mechanical Systems), optical, piezoelectric, or other suitable technologies.

Gyroscopes (112): Measure angular velocity (rotation rate) around three orthogonal axes (roll, pitch, yaw). In various embodiments, gyroscopes may have ranges such as ±250 deg/s to ±2000 deg/s, resolutions such as 0.01 deg/s to 0.1 deg/s, and sample rates such as 100 Hz to 1000 Hz. Various gyroscope technologies may be used including MEMS, fiber optic, ring laser, or other suitable technologies.

Optional Magnetometer (113): May measure magnetic field for heading determination.

### IMU Implementations:

The collision detection system can operate with various commercially available IMU modules combining accelerometers and gyroscopes in a single package. Examples of suitable IMU modules include, but are not limited to, consumer-grade, industrial-grade, and precision IMUs from various manufacturers. The invention is not limited to any particular IMU hardware or specifications.

### IMU Mounting and Installation (114):

IMU mounting location and method significantly affect signal quality:

Preferred Mounting Location: Centrally located on vehicle chassis, close to center of mass, rigidly mounted to structural frame. This position experiences representative accelerations from all collision directions.

Mounting Method: In various embodiments, rigid mechanical mounting using bolts or adhesive bonding may be employed. In some embodiments, soft mounts or vibration isolators may be used to filter out high-frequency mechanical noise while preserving collision signatures.

Orientation: IMU coordinate frame should be aligned with vehicle coordinate frame (X=forward, Y=left, Z=up, or similar convention) to simplify interpretation.

Environmental Protection: IMU should be enclosed in protective housing if located in areas exposed to moisture, dust, or mechanical impact.

### Multiple IMU Configuration (115) (Advanced Embodiment):

In some embodiments, multiple IMUs are installed at different vehicle locations:—Front IMU, Rear IMU, Left Side IMU, Right Side IMU—Enables impact localization by comparing timing and magnitude at different positions—Provides redundancy in case of sensor failure—In various embodiments, spacing may be selected based on vehicle size and geometry

### Sensor Data Interface (120):

IMU data is transmitted to the compute platform via standard interfaces:—SPI (Serial Peripheral Interface): High-speed serial interface (1-20 MHz clock), typical for direct IMU connections—I2C (Inter-Integrated Circuit): Lower-speed serial interface (100 kHz-1 MHz), adequate for many IMUs-UART/RS-232: Serial interface for some IMU modules—CAN Bus: Common in industrial vehicles, some IMU modules provide CAN interface—Ethernet: High-end IMUs may provide Ethernet interface with integrated sensor fusion

### Sensor Driver Software (121):

Low-level software drivers handle IMU communication:—Configure IMU parameters (sample rate, range, filtering)—Read sensor data at specified rate (typically 100-1000 Hz)—Perform sensor calibration compensation (bias removal, scale factor correction, axis alignment)—Timestamp data with high-precision time source-Buffer data for processing pipeline

### Compute Platform (130):

The compute platform executes collision detection and analysis algorithms:

Processor(s) (131): CPU and/or GPU for computation
I. Various processor architectures may be employed including ARM, x86, or other suitable architectures
II. For basic algorithms: Moderate performance CPU may be sufficient
III. For ML-based algorithms: Higher performance CPU or GPU may be beneficial

Memory (132): RAM for active data processing
I. Memory requirements vary based on implementation
II. IMU data buffering requires minimal memory
III. ML model execution memory requirements depend on model complexity

Storage (133): Non-volatile storage for collision event logs, configuration, software
I. Storage requirements vary based on logging detail and retention policies
II. Collision event storage requirements depend on logging detail per event

### Collision Detection and Analysis Module (140):

This software module implements the core collision detection algorithms:

Data Acquisition (141): Receives real-time IMU data stream from sensor drivers at configured sample rate.

Preprocessing and Filtering (142): Applies signal processing to reduce noise while preserving collision signatures:
I. Bias Removal: Subtracts sensor bias to center signals around zero
II. Low-Pass Filtering: Removes high-frequency noise (various filter types and cutoff frequencies may be employed)
III. High-Pass Filtering: Removes low-frequency drift and gravity component
IV. Band-Pass Filtering: Focuses on frequency range characteristic of collisions

Feature Extraction (143): Computes derived quantities useful for collision detection:
I. Acceleration Magnitude: |a|=√(a_x²+a_y²+a_z²)
II. Jerk (rate of change of acceleration): j=da/dt
III. Angular Velocity Magnitude: [ω]=√(ω_x²+ω_y²+ω_z²)
IV. Angular Acceleration: α=dω/dt
V. Frequency Domain Features: FFT (Fast Fourier Transform) to analyze frequency content

### Analysis Modules (150):

This subsystem analyzes processed IMU data to detect, classify, and assess collision events:

Anomaly Detection (151): Identifies deviations from normal operational patterns:
I. Threshold-Based Detection: Flags events when acceleration or jerk exceeds predefined thresholds
II. Statistical Anomaly Detection: Compares current signals to statistical models of normal operation
III. Machine Learning Anomaly Detection: Uses trained models (various ML algorithms including One-Class SVM, Isolation Forest, Autoencoders, or other suitable methods) to identify outliers

Event Classification (152): Categorizes collisions by type and cause:
I. Three-Tier Causation Classification: Analyzes impact direction vs. commanded trajectory direction and collision avoidance state to classify as: (1) external, (2) self_caused, or (3) uncertain requiring offline multi-modal analysis, with associated confidence score
II. Direction: Estimates impact direction
III. Collision Type: Identifies collision characteristics (head-on, side-swipe, rear-end, glancing)

Severity Assessment (153): Quantifies collision magnitude and potential damage:
I. Computes severity metrics (peak G-force, delta-V, energy, impulse)
II. Classifies severity level (minor, moderate, severe, critical)
III. Estimates potential for damage or injury

Cause Attribution (154): Determines collision responsibility and causation:
I. Analyzes temporal pattern (sudden onset, peak, decay)
II. Checks event duration characteristics
III. Evaluates multi-axis coordination (collisions affect multiple axes)
IV. Confirms sufficient energy content
V. Records contextual information (nearby vehicles if known, operational mode)

Reporting and Alerting (155): Generates notifications and reports:
I. Real-time alerts for high-severity collisions
II. Periodic summary reports (daily, weekly, monthly)
III. Integration with external systems (WMS, fleet management, safety systems)
IV. Event logging with timestamp, vehicle position, heading, state, IMU data window, computed features, classification results, and severity metrics

### Motion Planning and Control (160):

Provides vehicle control commands:—Planned trajectory: Intended vehicle path and velocity profile-Control commands: Steering, throttle, brake commands sent to vehicle platform-Control mode: Autonomous, manual, remote, or other control modes

Access to planned trajectory and control commands is critical for distinguishing self-caused collisions from external collisions. The fundamental distinguishing principle is directional analysis: self-caused collisions occur when the robot's commanded trajectory direction was aligned with the impact direction (robot was navigating toward the collision), while externally-caused collisions occur when the impact direction is inconsistent with the commanded trajectory direction (robot was struck from a direction it was not navigating toward). For example, if a robot moving forward is struck from the side (perpendicular impact), this indicates an externally-caused collision regardless of collision avoidance system state. If a stationary robot is struck, this is externally-caused since the robot had no commanded motion. This principle is robust to sensor limitations, late detection in blind intersection scenarios, and collision avoidance system performance variability.

### Vehicle State Estimation:

Provides current vehicle state information (not explicitly numbered in FIG. 1, but integrated with the collision detection system):—Localization: Vehicle position and orientation in warehouse (from SLAM, map matching, or other localization)—Odometry: Velocity and heading from wheel encoders, IMU integration, or sensor fusion-Load status: Whether vehicle is carrying a load, load weight, load height (from sensors or operational data)—Operational mode: Current operational state (idle, navigating, loading, unloading, manual control, etc.)

### World Model:

Maintains environmental understanding (not explicitly numbered in FIG. 1, but integrated with the collision detection system):—Static map: Pre-built map of warehouse layout-Dynamic objects: Tracked positions of other vehicles, pedestrians, equipment-Proximity information: Detected nearby objects and their relative positions

This contextual information helps interpret collision events. For example, if the robot detects a collision from the right side and the world model shows a human-operated forklift was nearby on the right at that time, this supports classification as an externally-caused collision.

### External System Interfaces:

The collision detection system integrates with various external systems:

Warehouse Management System (WMS) Interface (170): Sends collision event data to WMS for fleet-wide analytics, may receive operational context from WMS

Fleet Management System Interface (172): Provides collision statistics, trends, and alerts to fleet operators

Safety System Interface (173): Reports collision events to safety monitoring systems, may trigger safety responses

Maintenance System Interface (174): Alerts maintenance systems to inspect vehicles after severe collisions

Incident Logging System (175): Records collision events in central incident database

### Platform Controller (180):

Low-level vehicle control:—Motor controllers, brake controllers, steering actuators, safety systems

### B. IMU Signal Characteristics

Understanding IMU signal characteristics for different event types is essential for collision detection algorithm design:

### Normal Driving Operation:

During normal autonomous navigation:—Accelerations: Smooth changes corresponding to acceleration/deceleration and turning-Longitudinal (X-axis): Relatively low accelerations during gentle acceleration/braking-Lateral (Y-axis): Relatively low accelerations during turns-Vertical (Z-axis): Low accelerations from suspension dynamics-Angular Velocities: Smooth yaw rate during turns-Frequency Content: Dominated by low frequencies

### Pallet Loading/Unloading:

When forks engage or disengage from pallets:—Accelerations: Brief impulses during contact-Peak magnitudes: Moderate acceleration levels-Duration: Brief transient events-Primarily vertical (Z-axis) or longitudinal (X-axis) depending on engagement geometry-Angular Velocities: Minimal angular velocity change unless pallet is significantly off-center-Signature: Characteristic impulse followed by damped oscillation

### Floor Transitions and Bumps:

When vehicle traverses uneven flooring, thresholds, ramps:—Accelerations: Vertical impulses as wheels encounter features-Peak magnitudes: Moderate vertical acceleration levels-Duration: Brief impulse per wheel-Sequential pattern as front then rear wheels traverse-Angular Velocities: Pitch rate spikes as vehicle rocks over transition-Signature: Sequential vertical impulses with characteristic wheel-to-wheel timing

### Self-Caused Collision (Robot Hitting Obstacle):

When robot's autonomous navigation causes collision with static obstacle (wall, rack, equipment):—Accelerations: Deceleration in direction of travel-Peak magnitudes: Higher acceleration levels depending on approach speed and obstacle compliance-Duration: Transient deceleration event-Primarily in longitudinal axis (X) if front collision, aligned with direction of motion-Angular Velocities: Possible yaw/pitch rate spike if impact is off-center-Directional Relationship: Impact direction aligned with commanded trajectory direction; that is, robot was commanding motion toward the collision location-Navigation State: Robot actively executing commanded trajectory that would take it through the collision location

### Externally-Caused Collision (Another Vehicle Striking Robot):

When another vehicle (especially human-operated) strikes the robot:—Accelerations: Sudden acceleration in direction of impact—Peak magnitudes: Variable acceleration levels depending on striking vehicle mass, speed, and impact angle—Duration: Brief to moderate impact event (shorter for hard impacts, longer for glancing)—Direction inconsistent with robot's commanded trajectory direction—Angular Velocities: Large yaw rate if impact is eccentric (off center-of-mass)—Peak rates: Elevated angular velocities for eccentric impacts—Directional Relationship: Impact direction not aligned with commanded trajectory direction—Robot may be stationary (zero commanded velocity)—no commanded direction to align with—Impact from any direction not aligned with the commanded trajectory—Impact direction inconsistent with the robot's navigation intent—Signature: Sharp onset, peak, exponential decay; impact from direction the robot was not navigating toward-Robustness: Classification is independent of collision avoidance system performance, making it robust to late detection in blind intersections or sensor limitations

### Distinguishing Characteristics:

Key differences enabling classification:

| | Normal | Self-Caused | External | Ambiguous |
|---|---|---|---|---|
| Characteristic | Operations | Collision | Collision | (Offline Analysis) |
| Peak | Low | Moderate to high | Variable | Variable |
| Acceleration | | | | |
| Duration | Variable | Brief to moderate | Brief to | Brief to moderate |
| | | | moderate | |
| Impact Direction | Aligned | Aligned (toward | NOT Aligned | Aligned |
| vs. Trajectory | | obstacle) | | |
| Collision | No | No (failed to | N/A (not | Yes (detected but |
| Avoidance | | detect) | determinative) | couldn't avoid) |
| Active | | | | |
| Robot State | Commanded | Actively | Stationary or | Actively |
| | motion | navigating | any state | navigating then |
| | | | | braking |
| Real-Time | N/A | Definitive | Definitive | Requires multi- |
| Classification | | | | modal log |
| | | | | analysis |
| Frequency | Lower | Mid to higher | Mid to higher | Mid to higher |
| Content | frequencies | frequencies | frequencies | frequencies |

### II. Collision Detection Algorithms

### A. Signal Preprocessing and Filtering

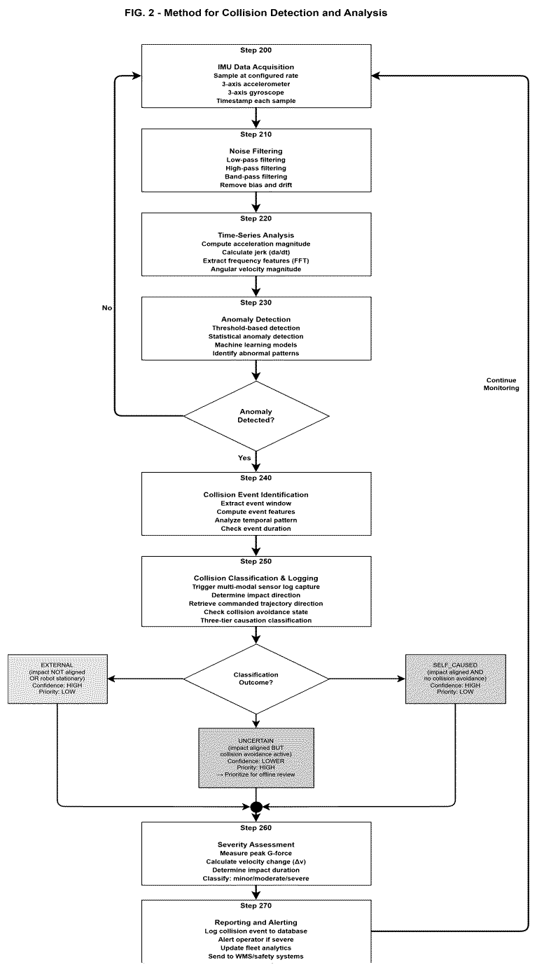

Referring to FIG. 2, collision detection begins with signal preprocessing to enhance signal-to-noise ratio:

```
    Step 200: IMU Data Acquisition
    Raw IMU data is acquired at configured sample rate:
    For each time step t:
```

| | |
|---|---|
| a_x(t), a_y(t), a_z(t) = read_accelerometers( ) | // m/s² |
| ω_x(t), ω_y(t), ω_z(t) = read_gyroscopes( ) | // rad/s or deg/s |
| timestamp(t) = get_high_precision_time( ) | // UTC time |

```
    Step 210: Noise Filtering
    Digital filters reduce measurement noise. Sensor biases (constant
offsets) are estimated during calibration and subtracted:
    // Bias removal
a_x_corrected(t) = a_x(t) − bias_a_x
a_y_corrected(t) = a_y(t) − bias_a_y
a_z_corrected(t) = a_z(t) − bias_a_z
[similar for gyroscopes]
```

For accelerometers, Z-axis bias includes gravity component. This may be removed or retained depending on implementation.

```
  Low-Pass Filter (removes high-frequency noise):
  // Various filter types and parameters may be employed
a_filtered = lowpass_filter(a_corrected, parameters)
  High-Pass Filter (removes low-frequency drift and quasi-static
components like gravity):
  // Various filter types and parameters may be employed
a_hp = highpass_filter(a_filtered, parameters)
  Band-Pass Filter (alternative: directly extract collision-relevant
  frequency band):
  // Various filter types and parameters may be employed
a_bp = bandpass_filter(a_corrected, parameters)
  Step 220: Time-Series Analysis and Feature Extraction
  Compute derived quantities useful for collision detection:
  Acceleration Magnitude:
  a_mag(t) = sqrt(a_x(t)² + a_y(t)² + a_z(t)²)
  Jerk (rate of change of acceleration):
  jerk_x(t) = (a_x(t) − a_x(t−1)) / Δt
jerk_mag(t) = sqrt(jerk_x(t)² + jerk_y(t)² + jerk_z(t)²)
  Angular Velocity Magnitude:
  ω_mag(t) = sqrt(ω_x(t)² + ω_y(t)² + ω_z(t)²)
  Angular Acceleration:
  α_x(t) = (ω_x(t) − ω_x(t−1)) / Δt
α_mag(t) = sqrt(α_x(t)² + α_y(t)² + α_z(t)²)
```

Moving Window Statistics (over past N samples, where N is configurable based on sample rate and desired window duration):

a_mean(t)=mean(a_mag(t−N:t))

a_std(t)=std(a_mag(t−N:t))

a_max(t)=max(a_mag(t−N:t))

Horizontal vs. Vertical Acceleration Decomposition (False Positive Reduction):

A critical technique for reducing false positives from floor surface irregularities is decomposing three-axis acceleration into horizontal plane components (X-Y axes) and vertical component (Z-axis):

// Compute horizontal plane acceleration magnitude
a_horizontal(t) = sqrt(a_x(t)² + a_y(t)²)
// Compute vertical acceleration magnitude
a_vertical(t) = abs(a_z(t))

### Physical Rationale:

Collisions from other vehicles striking the robotic vehicle produce primarily horizontal impacts because:—Colliding vehicles approach on the ground plane (X-Y)—Impact forces are transmitted laterally (front, rear, sides)—Energy transfer occurs predominantly in horizontal directions

Floor surface irregularities (cracks, expansion joints, ramps, transitions) produce primarily vertical vibrations because:—Wheel-suspension system responds to vertical floor displacement—Vertical accelerations do not indicate lateral collisions—Z-axis accelerations from floor bumps can exceed 2-5 m/s² without any collision Differential Threshold Strategy:

Apply different detection thresholds to horizontal vs. vertical components:

```
    // Thresholds are configurable based on vehicle characteristics and
    environment
THRESHOLD_HORIZONTAL = configured_value // Lower threshold
(more sensitive)
THRESHOLD_VERTICAL = configured_value // Higher threshold (less
sensitive)
If a_horizontal(t) > THRESHOLD_HORIZONTAL:
  Potential collision candidate (horizontal impact detected)
If a_vertical(t) > THRESHOLD_VERTICAL AND a_horizontal(t) <
THRESHOLD_HORIZONTAL:
  Floor surface anomaly (not a collision from another vehicle)
  Flag as non-collision operational event
```

Result: This approach reduces false positive collision detections in warehouse environments with imperfect floor conditions, while maintaining high sensitivity to actual lateral collisions from other vehicles.

### Step 230: Anomaly Detection

The processed IMU features are analyzed to detect anomalous patterns that deviate from normal operation, indicating potential collision events. Various detection approaches may be employed depending on deployment requirements, computational resources, and available training data:

### B. Machine Learning-Based Detection (Preferred Embodiment)

Preferred Approach: The preferred embodiment employs machine learning models that learn multi-dimensional temporal patterns across all IMU channels simultaneously. Unlike threshold-based methods that rely on scalar comparisons, pattern-based learning approaches capture complex time-varying signatures characteristic of collision events by processing time-series data in high-dimensional feature spaces. These models learn complex non-linear relationships and decision boundaries from training data using various machine learning architectures including tree-based ensemble methods, support vector machines, neural networks, and other supervised or unsupervised learning algorithms. The learned models adapt to varying operational conditions and provide superior detection accuracy and lower false positive rates compared to fixed threshold methods.

Machine learning-based collision detection evolves through deployment phases, starting with anomaly detection for rapid initial deployment and transitioning to supervised learning as labeled collision data accumulates from fleet operations:

### Phase 1—Anomaly Detection Approach (Initial Deployment):

The anomaly detection paradigm trains models exclusively on normal operational data, enabling deployment without requiring labeled collision examples. The model learns what “normal” operation looks like and flags deviations exceeding thresholds as potential collisions:

Training Phase: 1. Collect unlabeled normal operational data:—IMU data windows from routine operations: driving, turning, loading, unloading, stopping—Various operational conditions: different speeds, floor types, load weights—No collision events required

Train anomaly detection model using various approaches:
I. Neural network-based methods that learn compressed representations of normal patterns
II. Boundary-based methods that learn decision boundaries around normal operational data
III. Tree-based isolation methods that identify anomalous patterns
IV. Statistical methods that learn distribution of normal operation features
V. Other suitable anomaly detection algorithms

### Inference Phase:

For each IMU data window:

```
features = extract_features(imu_window)
anomaly_score = anomaly_model.score(features)
If anomaly_score > threshold:
  # Deviation exceeding threshold from normal operation detected
  trigger_collision_analysis( )
```

Advantages:—Rapid deployment without collecting collision data—No manual labeling required—Learns specific operational characteristics of deployment environment—Enables immediate production use

Phase 2—Supervised Learning Approach (Enhanced Performance with Accumulated Data):

The supervised learning paradigm trains models on labeled collision and non-collision data accumulated from fleet operations. Various model architectures can be employed depending on computational resources, data availability, and performance requirements:

### Training Phase:

Collect labeled training dataset from fleet operations:
I. Positive examples: IMU data windows from actual collision events captured across deployed fleet
   A. Labels verified through offline multi-modal log analysis
   B. Includes collision type, causation (external/self_caused/uncertain resolved), and severity
   C. Represents real-world collision scenarios in target warehouse environments
II. Negative examples: IMU data windows from normal operation across fleet
   A. Diverse operational conditions from multiple deployment sites

Feature engineering: Extract relevant features from each data window:
I. Statistical: mean, std dev, max, min, range, skewness, kurtosis of acceleration and angular velocity
II. Temporal: peak timing, rise time, decay time, duration
III. Frequency domain: FFT coefficients, dominant frequencies, spectral energy distribution
IV. Time-frequency: Wavelet transform coefficients, short-time FFT features

Train classifier using various supervised learning algorithms:
I. Tree-based ensemble methods
II. Maximum margin classifiers
III. Neural network architectures (including deep learning approaches)
IV. Gradient boosting algorithms
V. Other suitable supervised learning methods

### Inference Phase:

```
    For each new IMU data window W:
features = extract_features(W)
collision_probability = trained_model.predict_proba(features)
If collision_probability > THRESHOLD_P (e.g., 0.8):
  Classify as collision event
  collision_type = trained_model.predict_class(features)
```

### Unsupervised Learning Approach:

When labeled collision data is limited, unsupervised anomaly detection methods learn patterns of normal operation and flag deviations as potential collisions. Various unsupervised learning techniques may be employed:

Boundary-Based Methods:—Train on normal operational data only-Model learns boundary of normal operation in feature space-New data outside boundary classified as anomaly (potential collision)

Tree-Based Isolation Methods:—Use tree structures to isolate anomalous patterns—Anomalies (collisions) require fewer decision splits to isolate than normal data—Anomaly score based on isolation difficulty

Reconstruction-Based Methods:—Neural networks trained to reconstruct normal operational IMU data—Reconstruction error is low for normal data, high for anomalies—High reconstruction error indicates potential collision

### Deep Learning Approach (Advanced Neural Network Embodiment):

As a specific embodiment within the broader machine learning framework, deep neural networks can be employed for complex collision pattern recognition:

### Temporal Convolutional Networks:

The network processes multi-channel IMU data (accelerometer and gyroscope channels) simultaneously, applying temporal convolutions across time steps to learn multi-dimensional time-varying patterns in the sensor data. This captures complex temporal relationships across all measurement axes that would be missed by threshold-based methods examining individual channels independently.

Input: Raw IMU time series window containing multi-channel sensor data Architecture:
One or more convolutional layers for temporal feature extraction
Optional pooling or downsampling layers
One or more fully connected layers for classification
Output layer producing collision detection or classification results

Output: Collision detection results (binary detection, multi-class classification, probability scores, or other suitable output formats)

### Recurrent Neural Networks:

For temporal sequence modeling:

Input: IMU time series window

### Architecture:

One or more recurrent layers for sequential pattern learning
Optional additional processing layers
Output layer producing collision detection or classification results

Output: Collision detection results (binary detection, multi-class classification, probability scores, or other suitable output formats)

### C. Statistical Anomaly Detection (Alternative Embodiment)

Intermediate Approach: Statistical anomaly detection provides a middle ground between simple thresholds and full machine learning. This approach models normal operation statistically and detects deviations:

### Baseline Statistical Model:

During normal operation (no collisions), collect IMU data to build statistical model:

For each feature f (e.g., a_mag, jerk_mag, ω_mag):

Compute mean μ_f and standard deviation σ_f over training dataset

### Example

μ_a_mag=1.5 m/s² (mean acceleration magnitude during normal operation)
σ_a_mag=0.5 m/s² (standard deviation)

### Anomaly Score:

During operation, compute how many standard deviations current measurement deviates from normal:

```
    z_score(t) = (a_mag(t) − μ_a_mag) / σ_a_mag
If z_score(t) > THRESHOLD_Z:
  Flag anomaly
Typical THRESHOLD_Z = 3 to 5 (corresponding to 3σ to 5σ events)
```

### Multivariate Anomaly Detection:

Consider multiple features simultaneously using Mahalanobis distance:

```
    Feature vector: x(t) = [a_mag(t), jerk_mag(t), ω_mag(t), ...]
Mean vector: μ = [μ_a_mag, μ_jerk_mag, μ_ω_mag, ...]
Covariance matrix: Σ (captures correlations between features)
Mahalanobis distance: D_M(t) = sqrt((x(t) − μ)\hat{ }T Σ\hat{ }(−1) (x(t) − μ))
If D_M(t) > THRESHOLD_D:
  Flag multivariate anomaly
```

### Adaptive Thresholds:

Update statistical model online to adapt to changing conditions:

Use exponential moving average to update statistics:

μ_f(t)=α×μ_f(t−1)+(1−α)×f(t)

where α=0.99 to 0.999 (slow adaptation)

Exception: Exclude detected anomalies from model updates to prevent contamination

### D. Threshold-Based Collision Detection (Alternative Embodiment)

Simplified Approach: In resource-constrained deployments or applications requiring deterministic behavior, simpler threshold-based detection methods may be employed. While less sophisticated than pattern-learning approaches, threshold-based methods offer computational efficiency and predictable behavior:

The threshold-based approach uses fixed or adaptive thresholds:

### Threshold Comparison

If a_mag (t)>THRESHOLD_A:
Flag potential collision event at time t

THRESHOLD_A values are configurable based on:
Desired sensitivity level (minor, medium, or high sensitivity)
Vehicle characteristics (mass, suspension, wheel type)
Operational environment (floor conditions, traffic density)
Application requirements (false positive vs. false negative tolerance)

### Multi-Threshold Approach:

Use different thresholds for different severity levels:

```
    If a_mag(t) > CRITICAL_THRESHOLD:
  Severe collision event
Elself a_mag(t) > MODERATE_THRESHOLD:
  Moderate collision event
Elself a_mag(t) > MINOR_THRESHOLD:
  Minor collision event or operational impact
```

Where threshold values are determined empirically based on deployment requirements

Jerk Threshold (rate of change criterion):

Collisions have rapid onset, characterized by high jerk:

If jerk_mag (t)>THRESHOLD_J:
Flag potential collision event
Where THRESHOLD_J is configurable based on collision detection requirements

### Duration Criterion:

To avoid false positives from brief noise spikes, require threshold exceedance for minimum duration or over minimum number of samples:

If a_mag (t: t+N)>THRESHOLD_A for at least M consecutive samples: Confirm collision event
Where M is configurable based on sample rate and desired minimum event duration

Advantages of Threshold-Based Detection:—Simple, computationally efficient-Real-time operation on resource-constrained processors-Deterministic, predictable behavior-Easy to tune for specific applications

Limitations:—Fixed thresholds may not adapt to varying operational conditions—Difficulty distinguishing collision types—High false positive or false negative rates depending on threshold setting

### Step 240: Collision Event Identification

Once an anomaly is detected (Step 230), the system identifies and extracts the specific collision event by determining the event window boundaries, computing event-specific features, and isolating the collision signature from ongoing sensor data:

```
    If anomaly_detected at time t:
# Extract event window around detected anomaly
event_window = extract_time_window(t − pre_window, t +
post_window)
# Compute event-specific features
peak_acceleration = max(a_mag within event_window)
peak_angular_velocity = max(ω_mag within event_window)
impact_timestamp = time_of_peak_acceleration
event_duration = measure_event_duration(event_window)
# Analyze temporal pattern
rise_time = time_to_peak(event_window)
decay_time = time_from_peak(event_window)
# Confirm event meets collision criteria
If event_duration within expected_collision_duration_range:
  collision_event_confirmed = True
  proceed_to_classification(Step 250)
```

The event identification process extracts configurable time windows before and after the detected anomaly to capture the complete collision signature. Various temporal features characterize the event including peak values, durations, rise/decay times, and other pattern-specific metrics that enable subsequent classification and severity assessment.

### III. Collision Classification and Cause Attribution

### Step 250: Collision Classification and Logging

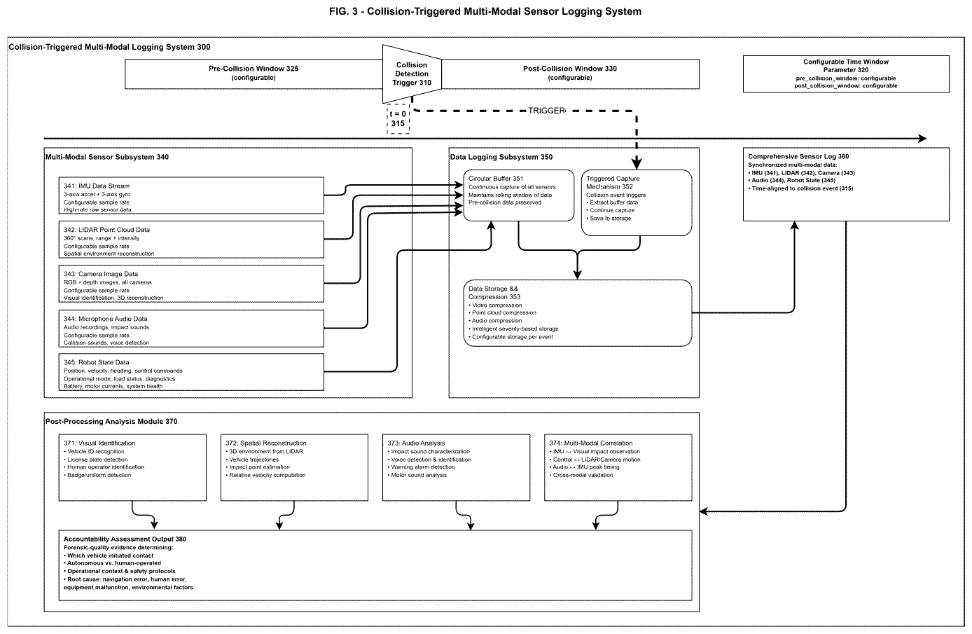

Once a collision event is identified (Step 240), the system classifies the collision cause and triggers comprehensive multi-modal data logging (FIG. 3, system 300) for forensic analysis:

A. Self-Caused vs. Externally-Caused Collision Distinction

The collision classification methodology distinguishes collision causes by analyzing the relationship between impact direction (determined from IMU acceleration anomalies), the robot's commanded navigation trajectory direction, and collision avoidance system state. The system provides three classification outcomes with associated confidence scores:
1. External: Impact direction inconsistent with commanded trajectory direction, or robot was stationary. The robot was struck from a direction it was not navigating toward.
2. Self_Caused: Impact direction consistent with commanded trajectory direction and no collision avoidance was active. The robot's navigation was directing it toward the obstacle without detecting the threat.
3. Uncertain: Impact direction consistent with commanded trajectory direction but collision avoidance was active at time of impact. This scenario is uncertain because it could represent either: (a) a self_caused collision where the robot detected the obstacle too late to stop, or (b) an external head-on collision where the robot attempted to avoid an incoming vehicle but couldn't stop in time.

For all collision events regardless of classification, the system triggers capture of comprehensive multi-modal sensor logs (FIG. 3) by the collision-triggered logging system. These logs include synchronized IMU data, LIDAR point clouds, camera images, audio recordings, and robot state data captured in configurable time windows before and after the collision event. This comprehensive forensic-quality documentation enables offline analysis and validation for any collision event. While external and self_caused classifications with high confidence scores may not require immediate offline review, uncertain classifications are prioritized for detailed post-processing analysis to determine definitive causation based on perception system detections, tracked vehicle trajectories, and temporal event sequences.

This three-tier classification is robust to sensor limitations and late detection scenarios while acknowledging when real-time classification has insufficient information for definitive causation determination. Each classification outcome generates a collision event record with accurate cause attribution and confidence score for safety analysis and operational improvement.

This methodology enables distinguishing collision causes based on directional analysis between IMU-measured impact direction and commanded trajectory direction:

### Self-Caused Collision:

Robot's autonomous navigation or control caused collision with static or moving obstacle.

Primary Indicator:—Impact direction ALIGNED with commanded navigation trajectory direction-robot was commanding motion toward the collision location

Supporting Indicators:—Robot was actively executing commanded motion (not stationary)—Commanded trajectory path would have taken robot through collision location-Perception system may have failed to detect obstacle in commanded path, or detected too late to avoid

### Detection Algorithm:

```
      If collision_detected at time t:
  impact_direction = estimate_impact_direction_from_IMU(t)
  trajectory_direction = get_commanded_trajectory_direction(t-Δt:t)
  robot_velocity = get_robot_velocity(t)
  collision_avoidance_active = check_collision_avoidance_state(t-Δt:t)
  # Trigger multi-modal sensor log capture for ALL collisions
  trigger_multi_modal_logging(t)
  # Check if stationary
  If robot_velocity ≈ 0:
    Classification = EXTERNAL
    Confidence = HIGH_CONFIDENCE_VALUE # High confidence - robot stationary
    Type = “External - robot was stationary”
    Priority = LOW # High confidence - offline review optional
    Return
  # Compute directional alignment between impact and commanded motion
  alignment = compute_directional_alignment(impact_direction, trajectory_direction)
  alignment_angle = angle_between(impact_direction, trajectory_direction)
  # Check if impact NOT aligned with commanded trajectory
  If alignment indicates NOT_ALIGNED:
    Classification = EXTERNAL
    # Confidence based on degree of misalignment (higher angle = higher confidence)
    Confidence = compute_confidence_from_angle(alignment_angle)
    Type = “External − struck from direction robot was not navigating toward”
    Priority = LOW # High confidence − offline review optional
    Return
  # Impact IS aligned with commanded trajectory
  # Check collision avoidance state to distinguish definitive vs uncertain cases
  If NOT collision_avoidance_active:
    # Robot navigating toward obstacle without detecting threat
    Classification = SELF_CAUSED
    Confidence = HIGH_CONFIDENCE_VALUE # High confidence − aligned impact, no
avoidance attempt
    Type = “Self_caused − robot trajectory directed toward undetected obstacle”
    Priority = LOW # High confidence − offline review optional
  Else:
    # Uncertain: Could be late detection OR head-on external collision
    Classification = UNCERTAIN
    Confidence = LOWER_CONFIDENCE_VALUE # Lower confidence − ambiguous
scenario
    Type = “Uncertain − collision avoidance active but impact still occurred”
    Priority = HIGH # Low confidence − prioritize for offline review
      Note: For ALL collision events regardless of classification, comprehensive multi-
modal sensor logs are captured (as described in FIG. 3, system 300). These logs include
synchronized IMU data (341), LIDAR point clouds (342), camera images (343), audio
recordings (344), and robot state data (345) captured in configurable time windows
(320) before and after the collision event. This provides forensic-quality documentation
for any collision. The Priority field indicates whether offline post-processing analysis
(370) should be immediately prioritized: HIGH priority for uncertain classifications
requiring detailed review of perception system detections, tracked object trajectories,
relative velocities, and temporal event sequences to determine definitive causation;
LOW priority for external and self_caused classifications with high confidence scores
where offline review is optional for validation purposes.
```

### Externally-Caused Collision:

Another vehicle or object struck the robot.

Primary Indicator:—Impact direction NOT ALIGNED with commanded navigation trajectory direction-robot was struck from a direction it was not navigating toward

Supporting Indicators:—Robot was STATIONARY when struck (no commanded motion)—Impact direction differs from commanded trajectory direction-Impact from directions inconsistent with robot's navigation intent-Collision avoidance may or may not have activated (not determinative for external collisions)

### Detection Algorithm:

```
      If collision_detected at time t:
  impact_direction = estimate_impact_direction_from_IMU(t)
  trajectory_direction = get_commanded_trajectory_direction(t-Δt:t)
  robot_velocity = get_robot_velocity(t)
  # Check if stationary
  If robot_velocity ≈ 0:
    Classification = EXTERNAL
    Confidence = HIGH_CONFIDENCE_VALUE
    Type = “Impact while stationary − externally caused”
  # Compute directional alignment
  alignment = compute_directional_alignment(impact_direction,
  trajectory_direction)
  # If impact NOT aligned with commanded trajectory
  If alignment indicates NOT_ALIGNED:
    Classification = EXTERNAL
    Confidence = compute_confidence_from_angle(alignment_angle)
    Type = “External collision − struck from direction inconsistent with
commanded trajectory”
  # Otherwise may be self_caused or uncertain (robot navigating toward
  impact)
```

### Impact Direction Estimation:

```
  Estimate the impact direction vector from acceleration anomaly:
  # Robot coordinate frame: X=forward, Y=left, Z=up
a_x, a_y, a_z = acceleration_anomaly_components
# Compute continuous impact direction vector
# The acceleration anomaly vector points in the direction the robot was
pushed impact_vector = [a_x, a_y, a_z]
# Normalize to unit vector (optional, for directional analysis)
impact_magnitude = sqrt(a_x² + a_y² + a_z²)
impact_direction_unit = impact_vector / impact_magnitude
# The impact direction can be expressed in various coordinate systems:
# - Cartesian coordinates: (a_x, a_y, a_z) in 3D space
# - Polar coordinates: (radius, angle) for 2D horizontal plane projection
# - Spherical coordinates: (radius, azimuth angle, elevation angle) in 3D
space
# - Cylindrical coordinates: (radius, azimuth angle, vertical component) in
3D space
# - Direction cosines: angles relative to coordinate axes
# - Quaternion representation: for orientation-based analysis
# - Other suitable coordinate representations
# For trajectory alignment analysis, compute angle between impact vector
# and commanded trajectory direction vector:
alignment_angle = angle_between(impact_direction_unit,
trajectory_direction_unit)
```

### Step 260: Severity Assessment

After classifying the collision (Step 250), the system quantifies the collision severity using multiple IMU-derived metrics to assess impact magnitude and potential damage:

### B. Collision Severity Assessment

Collision severity is quantified using multiple metrics:

### Peak Acceleration (G-Force):

Maximum acceleration magnitude during collision event:

a_peak=max (a_mag (t_start: t_end)) #where t_start, t_end define collision event window

g_force=a_peak/9.81 #Convert m/s² to g units

### Severity Classification by Peak G-Force:

```
    # Multi-level severity classification based on peak g-force thresholds
# Thresholds are configurable based on:
# - Vehicle structural characteristics and damage tolerance
# - Operational safety requirements
# - Maintenance intervention triggers
# - Fleet management policies
If g_force < THRESHOLD_1:
  Severity = MINOR
Elself THRESHOLD_1 ≤ g_force < THRESHOLD_2:
  Severity = MODERATE
Elself THRESHOLD_2 ≤ g_force < THRESHOLD_3:
  Severity = SEVERE
Else: # g_force ≥ THRESHOLD_3
  Severity = CRITICAL
# Where THRESHOLD_1 < THRESHOLD_2 < THRESHOLD_3
# Number of severity levels and threshold values are configurable
```

### Velocity Change (Delta-V):

```
  Change in velocity resulting from collision impact:
  # Integrate acceleration over collision duration
Δv = integrate(a(t), t_start, t_end)
# Approximation using trapezoidal rule
Δv ≈ Δt × sum(a(t_i)) for t_i in [t_start, t_end]
```

Delta-V is widely used in automotive collision analysis as it correlates with injury risk and structural damage.

### Collision Energy:

```
  Kinetic energy transferred during collision:
  # Estimate mass change in velocity
m_robot = robot_mass # kg
E_collision = 0.5 × m_robot × (Δv)² # Joules
```

### Collision Impulse:

Momentum change:

J=m_robot×Δv #N·s(Newton−seconds)

### Impact Duration:

Time from collision onset to conclusion:

Duration=t_end−t_start #seconds
#Duration characteristics vary based on:
#—Impact type (hard, moderate, soft, glancing)
#—Collision mechanics (elastic vs. inelastic)
#—Vehicle mass and structural compliance
#—Contact surface properties
#—Relative velocities
#Shorter durations typically indicate harder, more impulsive impacts
#Longer durations typically indicate softer, more gradual contact events
#Duration can be used as a severity indicator or collision type classifier

### Angular Velocity Change:

Change in rotational velocity (important for eccentric impacts):

Δω=max(ω(t))−ω(t_pre)#where t_pre is before collision

Large Δω indicates off-center impact causing vehicle rotation

### Composite Severity Score:

Combine multiple metrics into single score:

Severity_score=w1×(g_force/g_max)+w2×(Δv/Δv_max)+

w3×(Duration/Duration_ref)+ . . .
where:
   w1, w2, w3, . . . are configurable weights (typically summing to 1.0)
   g_max, Av_max, Duration_ref are normalization constants
#Weights are determined based on:
#—Application—specific severity criteria
#—Vehicle characteristics and structural vulnerability
#—Correlation with actual damage observations from fleet data
#—Operational priorities (safety, maintenance, liability)
#Various weighting schemes may be employed:
#—Equal weighting: all metrics contribute equally
#—Prioritized weighting: emphasize most damage-predictive metrics
#—Adaptive weighting: adjust based on collision type or severity level

### Step 270: Reporting and Alerting

After completing severity assessment (Step 260), the system generates collision event reports, triggers appropriate alerts to external systems, and stores comprehensive event data for analysis and accountability determination:

```
    # Generate collision event record with all computed information
collision_event = create_event_record(
  timestamp, classification, confidence, severity_metrics,
  impact_direction, vehicle_state, multi_modal_log_reference
)
# Store event locally and transmit to central systems
store_collision_event(collision_event)
transmit_to_warehouse_management_system(collision_event)
transmit_to_fleet_management_system(collision_event)
# Trigger alerts based on severity and classification
If severity_level in [SEVERE, CRITICAL]:
  trigger_immediate_alert(safety_system)
  trigger_maintenance_inspection_request( )
If classification == UNCERTAIN and confidence < threshold:
  prioritize_for_offline_review(HIGH_PRIORITY)
Else:
  mark_for_optional_validation(LOW_PRIORITY)
# Generate event summary report
generate_collision_report(collision_event)
```

The reporting and alerting system integrates with warehouse management systems (WMS), fleet management systems, safety systems, maintenance systems, and incident logging systems (as shown in FIG. 1, interfaces 170-175) to provide real-time collision notifications and enable comprehensive fleet-wide collision analytics.

### IV. Collision Event Logging and Reporting

Referring to FIG. 3, a collision-triggered multi-modal sensor logging system (300) captures comprehensive forensic-quality data for all collision events regardless of initial classification (external, self_caused, or uncertain). The system operates with configurable time window parameters (320) that define a pre-collision window (325) and a post-collision window (330) relative to the collision event timestamp (315). The pre-collision and post-collision window durations are configurable based on operational requirements, available storage capacity, sensor data rates, and forensic analysis needs.

The system comprises a multi-modal sensor subsystem (340) that continuously generates data from multiple sensor streams. The IMU data stream (341) provides high-rate three-axis acceleration and three-axis gyroscope measurements sampled at a configurable rate sufficient to capture the raw inertial signature of the collision event. The LIDAR point cloud data stream (342) provides environmental scans with range and intensity information at a configurable rate, enabling spatial environment reconstruction. The camera image data stream (343) captures RGB and/or depth images from onboard cameras at configurable frame rates, providing visual identification and 3D reconstruction capabilities. The microphone audio data stream (344) records audio at a configurable sampling rate, capturing collision sounds, voice detection, and environmental audio. The robot state data stream (345) logs vehicle position, velocity, heading, control commands, operational mode, load status, battery state, motor currents, and system health diagnostics at configurable logging rates.

The data logging subsystem (350) comprises a circular buffer (351) that continuously captures data from all sensor streams and maintains a rolling window of recent data, thereby preserving pre-collision data that would otherwise be lost. When a collision detection trigger (310) occurs at timestamp (315), a triggered capture mechanism (352) extracts the buffered pre-collision data and continues capturing post-collision data according to the configured time windows. The captured data is processed by a data storage and compression module (353) that applies appropriate compression algorithms including video compression for camera streams, point cloud compression for LIDAR data, and audio compression for microphone recordings. The compressed data storage requirements per collision event are configurable based on compression parameters and data retention policies. In advanced embodiments, intelligent storage management applies severity-dependent compression: high-severity collisions receive full multi-modal logs, moderate-severity collisions receive compressed versions, and low-severity events store only IMU and robot state data to manage storage resources efficiently.

The result is a comprehensive sensor log (360) containing synchronized multi-modal data from all sensor streams time-aligned to the collision event timestamp (315). This comprehensive log enables post-processing analysis through a post-processing analysis module (370) that performs several analytical functions. Collision events classified as uncertain with low confidence scores are automatically prioritized for immediate offline review, while external and self_caused classifications with high confidence scores are marked for optional validation review. A visual identification module (371) applies computer vision algorithms for vehicle ID recognition, license plate detection, human operator identification, and badge or uniform detection to identify parties involved in the collision. A spatial reconstruction module (372) generates 3D environment models from LIDAR and camera data, reconstructs vehicle trajectories, estimates impact points, and computes relative velocities. An audio analysis module (373) characterizes impact sounds, detects and identifies voices, detects warning alarms, and analyzes motor sounds for diagnostic purposes. A multi-modal correlation module (374) performs cross-modal validation by correlating IMU acceleration signatures with visual impact observations, correlating control commands with LIDAR and camera-observed vehicle motion, temporally aligning audio impact sounds with IMU acceleration peaks, and validating findings across multiple sensor modalities.

The output of the post-processing analysis is an accountability assessment (380) that provides forensic-quality evidence for determining which vehicle initiated contact, whether the other party was autonomous or human-operated, the operational context and adherence to safety protocols, and root cause analysis distinguishing between navigation errors, human errors, equipment malfunctions, and environmental factors. For uncertain classifications, this detailed offline analysis determines definitive causation. For high-confidence external and self_caused classifications, offline analysis validates the initial real-time classification. This comprehensive multi-modal approach enables objective, evidence-based collision investigation that far exceeds the capabilities of IMU-only collision detection systems.

### A. Event Data Capture

When collision is detected, comprehensive data is logged:

### Event Record Structure:

```
      CollisionEvent {
  // Temporal Information
  event_id: unique_identifier
  timestamp: UTC_timestamp (microsecond precision)
  // Vehicle State
  vehicle_id: robot_identifier
  position: {x, y, heading} // From localization system
  velocity: {v_x, v_y, v_heading}
  load_status: {loaded: true/false, weight: kg, height: m}
  operational_mode: {autonomous, manual, remote, idle}
  // IMU Data
  imu_data_window: {
    time_series: [configurable window around event]
    sample_rate: Hz
    accel_x[ ], accel_y[ ], accel_z[ ]
    gyro_x[ ], gyro_y[ ], gyro_z[ ]
  }
  // Collision Characterization
  detection_method: {threshold, statistical, ML_model}
  classification: {self_caused, external, uncertain}
  classification_confidence: float (0.0-1.0)
  offline_review_priority: {HIGH, LOW} // HIGH for uncertain, LOW
for high-confidence classifications
  impact_direction_vector: {x, y, z} // Continuous 3D impact direction
  vector
  impact_direction_angle: float // Optional: azimuth angle in robot frame
  impact_elevation: float // Optional: elevation angle from horizontal
  plane
  trajectory_alignment_angle: float // Angle between impact direction
and commanded trajectory
  collision_characteristics: {
    eccentricity: float, // 0 = centered, 1 = highly eccentric
    impulsiveness: float, // Measure of impact sharpness/duration
    additional_metrics: ...
  }
  multi_modal_log_captured: {true} // Always true - captured for ALL
  collisions
  // Severity Metrics
  peak_g_force: float
  delta_v: float (m/s)
  collision_energy: float (Joules)
  impulse: float (N·s)
  duration: float (seconds)
  delta_omega: float (rad/s or deg/s)
  severity_score: float
  severity_level: {minor, moderate, severe, critical}
  // Contextual Information
  nearby_vehicles: [{vehicle_id, distance, bearing}, ...]
  nearby_humans: [{person_id, distance, bearing}, ...]
  warehouse_zone: zone_identifier
  traffic_density: {vehicles_per_area}
  // Control Context
  commanded_velocity: {v_cmd_x, v_cmd_y}
  brake_command: float (0-1)
  steer_command: float (radians)
  // Diagnostic
  notes: text_description
  video_clip: reference_to_onboard_camera_recording (if available)
  witness_accounts: references (if collected)
}
```

### Data Storage:

Local Storage: Events stored on vehicle's non-volatile memory

Central Database: Events uploaded to warehouse server/cloud when network available

Retention: Configurable retention policy (e.g., 1 year for all events, indefinite for severe events)

### B. Collision Reports and Analytics

### Individual Event Report:

Generated for each collision, includes:—Event summary (when, where, what, severity)—IMU data visualization (time-series plots of acceleration and angular velocity)—Vehicle trajectory visualization (showing position before/during/after collision)—Severity metrics table-Classification and likely cause-Recommended actions (e.g., “Inspect vehicle for damage,” “Review traffic patterns in zone,” “Training for human operators”)

### Periodic Summary Reports:

Generated daily, weekly, or monthly:

Fleet-Wide Collision Statistics:—Total collisions by severity level-Collisions per vehicle per operating hour-Collision trends over time (increasing/decreasing)

Spatial Analysis:—Collision heat map: warehouse floor plan overlaid with collision frequency by location-Identifies high-risk zones requiring safety improvements

Temporal Analysis:—Collisions by time of day, day of week-Identifies periods of high collision risk (e.g., shift changes, peak traffic times)

Cause Attribution:—Percentage distribution across three classification outcomes: self_caused, external, and uncertain (requiring offline analysis)—Average confidence scores for each classification category—For external collisions: identification of human-operated vehicles frequently involved—For uncertain collisions: results of offline multi-modal analysis determining definitive causation-Root cause analysis for recurring collision patterns

Operational Insights:—Correlation between collision frequency and traffic density, shift staffing, operational tempo-Recommendations for traffic management improvements-Identification of vehicles or operators requiring additional training or attention

C. Integration with Warehouse Management Systems

The collision detection system integrates with WMS and other enterprise systems:

### Data Flow to WMS:

For each collision event:
event_summary=create_event_summary (collision_event)
WMS_API.report_collision (event_summary)

### WMS Actions:

Real-Time Alerts: WMS notifies supervisors, safety personnel, or maintenance staff of collision events based on severity

Traffic Management: WMS may adjust vehicle routing to avoid high-collision zones

Incident Tracking: WMS logs collision in incident database for safety compliance and analysis

Performance Metrics: WMS includes collision frequency in vehicle/fleet performance KPIs

Integration with Other Systems:

Fleet Management System:—Provides vehicle health monitoring-Triggers maintenance inspections after severe collisions-Tracks cumulative collision exposure for each vehicle

Safety Management System:—Aggregates collision data with other safety incidents (near-misses, human injuries)—Generates safety reports for regulatory compliance-Identifies systemic safety issues requiring intervention

Human Resources/Training System:—If external collisions frequently involve specific human operators, flags for additional training-Provides collision data for training program development

Insurance/Risk Management:—Provides objective collision data for insurance claims-Enables evidence-based risk assessment and insurance premium negotiation

### V. Advanced Embodiments and Variations

### A. Multi-IMU Configuration

In advanced embodiments, multiple IMU sensors are installed at spatially distributed vehicle locations:

### Spatial Distribution:

#Multiple IMU sensors are positioned at different locations throughout the vehicle structure
#Placement is determined based on:
#—Vehicle geometry and structural layout
#—Desired spatial coverage for impact localization
#—Mounting location accessibility and structural integrity
#—Sensor field of view and measurement objectives
#Example configuration: N IMU sensors at positions P_1, P_2, . . . , P_N
#where each position P_i={x_i, y_i, z_i} in vehicle coordinate frame
#Various spatial arrangements may be employed:
#—Perimeter placement: sensors distributed around vehicle exterior regions
#—Volumetric distribution: sensors distributed throughout vehicle volume
#—Strategic placement: sensors at structurally significant locations
#—Reference sensor: optional sensor at reference location (e.g., geometric center or center of mass)

### Impact Localization:

By comparing timing and amplitude of signals at spatially distributed IMUs, impact location can be estimated:

```
  For collision event with N IMU sensors at known positions P_1, P_2,
  ..., P_N:
# Collect detection times and peak amplitudes from all sensors
t_i = detection_time(IMU_i) for i = 1 to N
a_i = peak_amplitude(IMU_i) for i = 1 to N
# Timing-based localization: earlier detection indicates proximity to
impact earliest_sensor = argmin(t_i)
# Impact occurred near position P_earliest_sensor
# Amplitude-based localization: higher amplitude indicates proximity
to impact highest_amplitude_sensor = argmax(a_i)
# Impact occurred near position P_highest_amplitude_sensor
# Combined analysis: use both timing and amplitude information
impact_location_estimate = localization_algorithm(t_i, a_i, P_i)
# Returns continuous position estimate or confidence map over vehicle
surface
```

### Collision Wave Propagation Analysis:

```
  Collision impact creates mechanical wave propagating through vehicle
  structure:
  # Mechanical wave propagation characteristics depend on:
# - Material properties (wave velocity in structural materials)
# - Vehicle geometry (distances between sensor locations)
# - Structural composition (homogeneous vs. composite structures)
# - Wave propagation mode (compression, shear, surface waves)
# General propagation model:
propagation_velocity = material_dependent_wave_speed
distance_between_sensors = | |P_i - P_j| |
propagation_time = distance_between_sensors / propagation_velocity
# Time difference detection:
# If IMU sample rate is sufficiently high relative to propagation time,
# time-of-arrival differences between sensors can be measured and used
# for impact localization via triangulation or time-difference-of-arrival
(TDOA) methods
# The feasibility of timing-based localization depends on:
# - IMU sampling rate relative to propagation times
# - Sensor synchronization accuracy
# - Signal processing techniques for time-of-arrival estimation
```

Benefits of Multi-IMU:—Improved impact localization (which part of vehicle was struck)—Redundancy (if one IMU fails, others continue operating)—Better characterization of vehicle structural response to impacts

Challenges:—Increased cost (multiple IMU sensors)—More complex data processing and sensor fusion—Synchronization requirements between IMUs

### B. Machine Learning Model Training and Deployment

### Evolutionary Training Approach:

The machine learning approach evolves as the deployed fleet accumulates operational experience:
Phase 1—Initial Deployment (Anomaly Detection):—Train unsupervised anomaly detection models on normal operational IMU data-Learn baseline patterns: acceleration, deceleration, turning, loading, unloading, floor transitions-Detect collisions as deviations from normal operational patterns-No labeled collision examples required for initial deployment-Enables rapid fleet deployment without extensive collision data collection
Phase 2—Fleet-Scale Data Accumulation:—As collisions occur, comprehensive multi-modal sensor logs are captured for ALL events-Offline analysis (particularly for uncertain classifications) determines definitive causation—Each analyzed collision becomes a verified labeled training example with:—IMU signature-Verified causation (external, self_caused, or validated uncertain case)—Collision type and severity-Environmental context-Fleet-wide deployment creates statistically robust labeled dataset over time
Phase 3—Hybrid Ensemble with Dynamic Weighting:—Deploy supervised learning model in parallel with anomaly detection model-Train supervised model on accumulated labeled collision dataset plus normal operational data-Supervised model learns to distinguish:—Collisions from operational events (detection)—Collision types and characteristics (classification)—Causation patterns (enhanced three-tier classification)—Ensemble fusion combines both model outputs: ′″ collision_score=w_anomaly×anomaly_score+w_supervised×supervised_probability

Where weights evolve over time (exemplary values):—Initially (e.g., <100 labeled collisions): w_anomaly=0.9, w_supervised=0.1-Intermediate (e.g., 100-500 collisions): w_anomaly=0.6, w_supervised=0.4-Mature deployment (e.g., 500-1000 collisions): w_anomaly=0.4, w_supervised=0.6-Large-scale (e.g., >1000 collisions): w_anomaly=0.2-0.3, w_supervised=0.7-0.8

Note: Actual threshold values and weight schedules are configurable based on deployment scale, data quality, model performance, and operational requirements. ′″-Anomaly detection retained permanently for:—Novel collision types not in training data—Robustness against distribution shift-Detecting previously unseen collision scenarios—Progressive weight adjustment as fleet scales and labeled data grows—Both models continuously retrained on accumulating data

### Hybrid Evolutionary System Architecture:

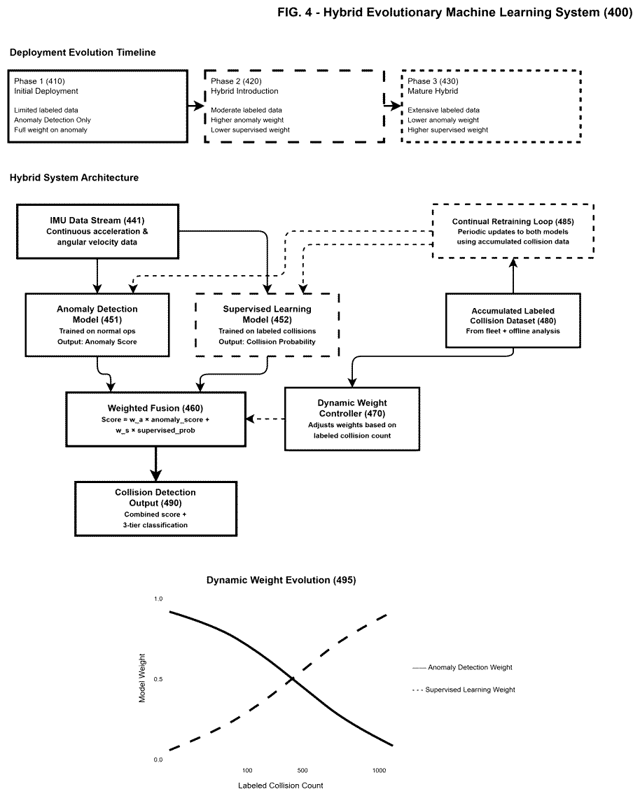

Referring to FIG. 4, a hybrid evolutionary machine learning system (400) implements the progressive transition from anomaly detection to supervised learning as the deployed fleet accumulates labeled collision data. The system progresses through three distinct deployment phases that correspond to the maturity of the labeled collision dataset. The specific threshold values for transitioning between phases are configurable and the values described herein are exemplary rather than limiting.
Phase 1—Initial Deployment (410) represents the system configuration when insufficient labeled collision events have been accumulated to train a supervised model. In one example, this may correspond to 0-100 labeled collision events, though the actual threshold is configurable based on model requirements, data quality, and operational constraints. During this phase, anomaly detection operates as the sole collision detection mechanism with a weight of 1.0, enabling immediate production deployment without requiring pre-collected labeled collision data.
Phase 2—Hybrid Introduction (420) begins when the fleet has accumulated sufficient labeled collision events to train an initial supervised learning model. In one example, this may correspond to 100-500 labeled collision events from actual operational collisions verified through offline multi-modal log analysis, though the actual threshold range is configurable. During this phase, a supervised learning model is introduced and operates in parallel with the anomaly detection model. Weights are dynamically adjusted (for example, within the range of 0.6-0.9 for anomaly detection and 0.1-0.4 for supervised learning), with progressive adjustment favoring supervised learning as more labeled data accumulates.
Phase 3—Mature Hybrid (430) represents the system configuration when a substantial labeled collision dataset has been accumulated from fleet-wide operations. In one example, this may correspond to 500 or more labeled collision events, though the actual threshold is configurable based on deployment scale and data accumulation rate. During this mature phase, the supervised learning model receives higher weight (for example, 0.6-0.8) while anomaly detection is retained with lower weight (for example, 0.2-0.4) to maintain capability for detecting novel collision types not represented in the training dataset.

The hybrid system architecture comprises an IMU data stream (441) providing continuous acceleration and angular velocity measurements that feed into two parallel processing paths. The anomaly detection model (451) has been trained on normal operational data and outputs an anomaly score indicating degree of deviation from learned baseline patterns. The supervised learning model (452) has been trained on the accumulated labeled collision dataset and outputs a collision probability along with predicted collision type and causation classification.

A weighted fusion module (460) combines the outputs from both models using the formula:

collision_score=w_anomaly×anomaly_score+w_supervised×

supervised_probability

The weights (w_anomaly and w_supervised) are determined by a dynamic weight controller (470) that continuously monitors the size and quality of the accumulated labeled collision dataset (480) collected from the entire deployed fleet. As this dataset grows from fleet-wide operations and longer deployment duration, the weight controller progressively shifts emphasis from anomaly detection toward supervised learning while maintaining anomaly detection capability for robustness against novel collision scenarios.

A continual retraining loop (485) periodically updates both the anomaly detection model (451) and supervised learning model (452) using newly accumulated collision data from fleet operations. This enables both models to continuously improve and adapt to evolving operational conditions and collision patterns.

The collision detection output (490) provides a combined collision detection score along with three-tier causation classification (external, self_caused, uncertain) and associated confidence scores, leveraging the complementary strengths of both detection approaches.

A weight evolution graph (495) illustrates the dynamic progression of model weights as a function of accumulated labeled collision count. The anomaly detection weight curve shows a decreasing trajectory from 1.0 (initial deployment) to 0.2-0.3 (large-scale deployment with 1000+ labeled collisions). Conversely, the supervised learning weight curve shows an increasing trajectory from 0.0 (initial deployment) to 0.7-0.8 (large-scale deployment). This progressive weight evolution enables the system to continuously improve detection accuracy and causation classification performance as the deployed fleet scales, while maintaining robustness through the retained anomaly detection component.

### Training Data Collection Strategies:

### Fleet-Generated Real-World Data (Primary Source):

I. Collision events from deployed fleet with offline-verified labels
II. Captures actual warehouse collision scenarios and operational conditions
III. Scales naturally with fleet size and deployment duration

### Simulated Collisions (Initial Bootstrapping):

I. Conduct controlled collision tests with robot in safe environment or purely in simulation
II. Systematically vary collision parameters (speed, angle, mass, impact location)
III. Label each event with ground truth (type, cause, severity)
IV. Generate initial training dataset for early supervised learning adoption

### Augmented Data:

I. Apply data augmentation to existing collision events
II. Add synthetic noise, time warping, amplitude scaling
III. Increases dataset size and model robustness

### Transfer Learning:

I. Pre-train model on large dataset from similar application
II. Fine-tune on specific warehouse collision data
III. E.g., automotive collision detection adapted for industrial vehicles

### Model Deployment:

```
      # Edge deployment (on-vehicle inference)
# Export trained model to deployment format suitable for target platform
trained_model.export(format=deployment_format)
deploy_to_vehicle(model=collision_detector,
device=compute_platform)
# Deployment formats depend on model type and platform:
# - Serialized model files (platform-specific or platform-independent
formats)
# - Compiled inference libraries
# - Platform-optimized model representations
# - Hardware-accelerated inference formats
# Real-time inference on vehicle
For each IMU data window:
  features = preprocess(imu_data_window)
  collision_result = model.predict(features)
  # Result may be: binary decision, probability score, multi-class
  classification, etc.
  If collision_detected(collision_result, detection_criteria):
    trigger_collision_event( )
```

### Continual Learning and Model Evolution:

The system supports continual learning at fleet scale, leveraging the comprehensive multi-modal sensor logs captured for every collision event. The specific threshold values, update frequencies, and weight schedules described below are exemplary and configurable based on deployment requirements:

### Fleet-Scale Model Update Cycle:

1. Collect collision events from entire fleet (e.g., weekly or monthly intervals)
   Each event includes IMU data+verified causation label
   Causation labels from offline multi-modal log analysis
   Particularly valuable: uncertain cases resolved to definitive causation
2. Accumulate labeled dataset (threshold values exemplary):
   If dataset_size<threshold (e.g., 100 events as an example): Continue using anomaly detection model
   Else if dataset_size>=threshold (e.g., 100+ events as an example): Proceed to supervised learning transition
3. Train enhanced supervised model:
   Positive examples: Labeled collision events (external, self_caused, uncertain)
   Negative examples: Normal operational data
   Train model to predict: collision detection+causation classification
4. Validate model performance:
   Test on held-out collision events
   Compare accuracy vs current anomaly detection model
   Measure improvements in detection and causation classification
5. Deploy updated model if performance improved:
   Push model update to entire fleet
   Gradual rollout with A/B testing
   Monitor performance in production
6. Continue accumulating data:
   Each new collision adds to training dataset
   Periodic retraining (e.g., monthly) with growing dataset
   Progressive performance improvement over time

Key Advantages of Fleet-Scale Continual Learning:—No pre-deployment labeled collision data required—Rapid initial deployment with anomaly detection—Natural transition to supervised learning as data accumulates—Fleet size directly correlates with training data quantity—Models learn actual collision scenarios in target environment—Continuous improvement throughout system lifecycle

### C. Predictive Collision Risk Assessment

Beyond reactive collision detection, proactive risk assessment:

### Collision Risk Factors:

```
    Analyze conditions associated with increased collision frequency:
    Risk_factors = {
  traffic_density: vehicles_per_area
  time_of_day: hour (shift changes = high risk)
  warehouse_zone: zone_id (some zones have higher collision rates)
  vehicle_load_status: loaded/unloaded (loaded vehicles have different
  dynamics)
  operator_experience: hours_of_operation (new operators = higher
  risk)
}
Collision_risk_model:
  Input: Risk_factors
  Output: Probability of collision in next N minutes
```

### Predictive Model Application:

If predicted_collision_risk>threshold:

### Actions:

Reduce maximum vehicle speed in high-risk zones
Alert nearby human operators to increase caution
Adjust traffic routing to reduce vehicle density
Increase sensor vigilance (higher update rates)

Benefits:—Proactive collision prevention—Optimized traffic management-Improved safety without overly conservative speed limits

D. Comparison with External Sensor Data

In embodiments with both IMU and external sensors (cameras, LIDAR):

### Sensor Fusion for Collision Confirmation:

```
      IMU_collision_detected = check_IMU_signals( )
Vision_collision_detected = check_camera_for_impact( )
LIDAR_collision_detected = check_LIDAR_for_contact( )
If IMU_collision_detected:
  Collision_confidence = HIGH
  If Vision_collision_detected OR LIDAR_collision_detected:
    Collision_confidence = VERY HIGH
    Additional_context = extract_visual_or_lidar_context( )
    # E.g., identify striking vehicle from camera image
```

### Complementary Roles:

External Sensors: Collision AVOIDANCE (preventing robot from causing collisions)

IMU: Collision DETECTION (detecting all collisions including those caused by external factors)

Combined system provides comprehensive safety coverage.

### Other Implementation Options

It should be understood that the example embodiments described above may be implemented in many different ways. In some instances, the various “data processors” may each be implemented by a physical or virtual general purpose computer having a central processor, memory, disk or other mass storage, communication interface(s), input/output (I/O) device(s), and other peripherals. The general-purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system. One or more central processor units are attached to the system bus and provide for the execution of computer instructions. Also attached to system bus are typically I/O device interfaces for connecting disks, memories, and various input and output devices. Network interface(s) allow connections to various other devices. One or more memories provide volatile and/or non-volatile storage for computer software instructions and data used to implement an embodiment. Disks or other mass storage provides non-volatile storage for computer software instructions and data used to implement, for example, the various procedures described herein.

Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); storage including magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

The above description included an explanation of several example embodiments. It should be understood that while a particular feature may have been disclosed with respect to only one of several embodiments, that particular feature may be combined with one or more other features of the other embodiments as may be desired and advantageous for any given or particular application. It is, of course, not possible to describe every conceivable combination of components or methodologies for purposes of describing the innovations herein, and one skill in the art may now, in light of the above description, recognize that many further combinations and permutations are possible. Also, to the extent that the terms “includes,” and “including” and variants thereof are used in either the detailed description or the claims, these terms are intended to be inclusive in a manner similar to the term “comprising”.

It also should be understood that the block and flow diagrams may include more or fewer elements, be arranged differently, or be represented differently. The computing devices, processors, controllers, firmware, software, routines, or instructions as described herein may also perform only certain selected actions and/or functions. Therefore, it will be appreciated that any such descriptions that designate one or more such components as providing only certain functions are merely for convenience.

When a series of steps has been described above with respect to the flow diagrams, the order of the steps may be modified in other implementations. In addition, the operations and steps may be performed by additional or other modules or entities, which may be combined or separated to form other modules or entities. For example, while a series of steps has been described with regard to certain figures, the order of the steps may be modified in other implementations consistent with the principles explained herein. Further, non-dependent steps may be performed in parallel. Further, disclosed implementations may not be limited to any specific combination of hardware.

No element, act, or instruction used herein should be construed as critical or essential to the disclosure unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

Accordingly, the subject matter covered by this patent is intended to embrace all such alterations, modifications, equivalents, and variations that fall within the spirit and scope of the claims that follow.

1. A collision detection and analysis system for detecting and characterizing physical impacts when other vehicles strike a robotic industrial vehicle operating in a warehouse or industrial environment, comprising:
an Inertial Measurement Unit (IMU) mounted on said robotic industrial vehicle, said IMU comprising at least one three-axis accelerometer and at least one three-axis gyroscope generating continuous measurements of linear acceleration and angular velocity;
one or more processors receiving IMU data from said IMU and executing collision detection software stored in non-transitory computer-readable memory;
wherein said collision detection software is configured to:
(a) apply digital filtering to attenuate noise while preserving transient acceleration signatures characteristic of collision impacts,
(b) detect collision events by identifying anomalous acceleration patterns in said filtered IMU data that deviate from baseline operational characteristics, wherein said collision detection prioritizes acceleration components in a horizontal plane over acceleration components in a vertical axis to reduce false positives from floor surface irregularities,
(c) determine an impact direction from said detected anomalous acceleration patterns,
(d) retrieve commanded navigation trajectory data indicating a direction of commanded motion of said robotic industrial vehicle at a time of collision,
(e) retrieve collision avoidance system state data indicating whether emergency braking or collision avoidance maneuvers were active at said time of collision,
(f) classify collision cause into one of three categories based on analyzing relationships between said impact direction, said direction of commanded motion, and said collision avoidance system state:
(g) external collision when said impact direction is inconsistent with said direction of commanded motion or said robotic industrial vehicle was stationary,
(ii) self-caused collision when said impact direction is consistent with said direction of commanded motion and no collision avoidance was active, or
(iii) uncertain collision requiring offline analysis when said impact direction is consistent with said direction of commanded motion but collision avoidance was active,
(g) assess collision severity using metrics including peak acceleration magnitude, velocity change, or impact duration,
(h) generate collision event records including timestamp, vehicle position, vehicle state, IMU data surrounding the event, collision classification, and severity assessment, and
(i) store said collision event records for subsequent analysis;
thereby enabling determination of whether collisions resulted from autonomous navigation of said robotic industrial vehicle or from other vehicles striking said robotic industrial vehicle, providing objective collision cause attribution for liability assessment and operational improvement.

2. The system of claim 1, wherein said classifying of collision cause further comprises:
computing a directional alignment metric between a vector representing said impact direction and a vector representing said direction of commanded motion;
computing a confidence score for each collision classification based on degree of alignment or misalignment between said impact direction and said direction of commanded motion, wherein external collisions receive high confidence scores when said directional alignment metric indicates misalignment, self-caused collisions receive high confidence scores when said directional alignment metric indicates alignment and no collision avoidance was active, and uncertain collisions are classified when said directional alignment metric indicates alignment but collision avoidance was active, wherein causation confidence is lower due to ambiguity between self-caused and external scenarios; and
triggering capture of comprehensive multi-modal sensor logs for all collision classifications.

3. The system of claim 1, wherein said collision detection software is configured to distinguish collision events from operational vibrations by:
analyzing multi-axis acceleration data to differentiate between collision-induced acceleration patterns and vibration patterns from normal operations including pallet loading, pallet unloading, floor surface transitions, and vehicle acceleration or deceleration;
identifying characteristics of collision events including sudden onset acceleration spikes, multi-axis coordination indicating external impact forces, and frequency content distinct from operational vibrations; and
filtering out non-collision acceleration anomalies caused by floor surface variations, load handling operations, and commanded vehicle motion;
thereby enabling robust collision detection that reduces false positives from routine warehouse operations while maintaining sensitivity to actual collision events from other vehicles.

4. The system of claim 1, wherein said assessing collision severity comprises:
determining one or more physical impact metrics from said filtered IMU data over a collision event window, said physical impact metrics including at least:
(a) peak acceleration magnitude,
(b) velocity change magnitude, and
(c) impact duration;
generating a composite severity score based on a combination of said physical impact metrics, wherein said composite severity score emphasizes peak acceleration and velocity change; and
classifying said collision into severity categories based on comparing said composite severity score to threshold values;
wherein said classifying said collision further enables response actions scaled to collision magnitude, minimizing unnecessary operational disruption from minor collisions while ensuring immediate intervention for severe collisions that may cause equipment damage or human injuries.

5. The system of claim 1, wherein said collision detection software implements a hybrid evolutionary machine learning approach that continuously improves over a deployment lifecycle, comprising:
an anomaly detection model trained on historical IMU data from normal operational conditions to learn baseline patterns of normal vehicle operation, enabling initial collision detection as deviations from learned normal operational patterns without requiring labeled collision event examples;
a model evolution subsystem configured to:
(a) accumulate collision event records from said robotic industrial vehicle and from a fleet of robotic industrial vehicles over time, wherein said collision event records include IMU data and verified causation labels determined from offline analysis of multi-modal sensor logs,
(b) when accumulated collision event records exceed a threshold quantity, train a supervised learning model using said accumulated collision event records as labeled training examples along with normal operational data, said supervised learning model trained to detect collision events and classify collision causation,
(c) deploy said supervised learning model to operate in parallel with said anomaly detection model in an ensemble configuration,
(d) compute a collision detection output as a weighted combination of an anomaly score from said anomaly detection model and a collision probability from said supervised learning model, wherein weights applied to each model are dynamically adjusted based on quantity and quality of accumulated labeled collision data,
(e) initially assign higher weight to said anomaly detection model when labeled collision data is limited, and progressively increase weight assigned to said supervised learning model as labeled collision data accumulates from increasing fleet size and longer deployment duration, and
(f) periodically retrain both said anomaly detection model and said supervised learning model as additional collision event records accumulate from fleet-wide deployment;
wherein said hybrid approach maintains said anomaly detection model to detect novel collision types not represented in accumulated training data while leveraging said supervised learning model to improve accuracy on known collision patterns;
thereby enabling progressive improvement in collision detection and causation classification performance that scales with both fleet size and deployment duration without requiring pre-deployment collection of extensive labeled collision datasets.

6. The system of claim 1, further comprising:
a data logging subsystem operably connected to said collision detection software, to a plurality of multi-modal sensors on said robotic industrial vehicle including LIDAR sensors, camera sensors, and microphone sensors, and to a vehicle state database storing robot operational parameters;
wherein said collision detection software is configured to:
upon detecting a collision event, trigger said data logging subsystem to capture and store a comprehensive sensor log comprising:
(a) high-rate IMU data for a predetermined time window preceding said collision event and a predetermined time window following said collision event,
(b) LIDAR point cloud data from said LIDAR sensors for said predetermined time windows,
(c) image data from said camera sensors for said predetermined time windows,
(d) audio data from said microphone sensors for said predetermined time windows, and
(e) robot state data including vehicle position, velocity, heading, control commands, and operational mode for said predetermined time windows;
wherein said predetermined time window is a configurable parameter stored in system configuration; and
wherein said comprehensive sensor log enables post-processing analysis using multi-modal data to identify responsible parties, reconstruct collision circumstances, determine collision cause attribution, and support accountability assessment in warehouse environments with mixed autonomous and human-operated vehicle traffic;
wherein collision events with uncertain classification and low confidence scores are prioritized for immediate offline review using said comprehensive sensor log, while collision events with external or self_caused classification and high confidence scores are available for optional validation review;
thereby providing forensic-quality collision documentation for all collision events that combines direct physical impact measurement from IMU sensors with visual, spatial, and auditory context from external sensors for comprehensive post-event analysis and validation.

7. The system of claim 1, further comprising:
a communication interface for transmitting collision event data to a warehouse management system or fleet management system;
wherein said collision detection software is configured to:
(a) generate summary reports of collision events over specified time periods,
(b) compute collision statistics including collision frequency, collision severity distribution, and collision cause distribution,
(c) create spatial collision heat maps identifying locations in a warehouse environment with high collision frequency, and
(d) transmit said summary reports, collision statistics, and spatial collision heat maps to said warehouse management system for operational analysis and safety improvement.

8. The system of claim 1, wherein said collision detection software is further configured to:
monitor collision event records over time to identify patterns;
when a threshold number of externally-caused collisions from a same direction or in a same warehouse zone is detected within a predetermined time window, generate a safety alert indicating a systematic collision risk;
when collision frequency exceeds a threshold rate, recommend operational adjustments including speed reductions, traffic routing changes, or increased human operator training; and
transmit said safety alerts and recommendations to warehouse supervisors or safety personnel.

9. The system of claim 5, wherein said collision detection further comprises:
frequency domain analysis configured to transform IMU acceleration data to identify dominant frequency components; and
a frequency-based classifier configured to distinguish collision events from non-collision events based on characteristic frequency signatures;
wherein said frequency-based classifier reduces false positive collision detection by distinguishing collision events from operational vibrations based on spectral characteristics.

10. A method for detecting and characterizing physical impacts when other vehicles strike a robotic industrial vehicle operating in a warehouse or industrial environment, comprising:
acquiring, from an Inertial Measurement Unit (IMU) mounted on said robotic industrial vehicle, continuous measurements of linear acceleration and angular velocity;
filtering said measurements to attenuate noise while preserving transient signals characteristic of collision impacts;
detecting collision events by identifying anomalous acceleration patterns in said filtered measurements that deviate from baseline operational characteristics;
for each detected collision event:
(a) determining an impact direction from said anomalous acceleration patterns,
(b) retrieving commanded navigation trajectory data indicating a direction of commanded motion of said robotic industrial vehicle at a time of collision,
(c) retrieving collision avoidance system state data indicating whether emergency braking or collision avoidance maneuvers were active at said time of collision,
(d) classifying collision cause into one of three categories based on analyzing relationships between said impact direction, said direction of commanded motion, and said collision avoidance system state, wherein:
(e) when said impact direction is inconsistent with said direction of commanded motion or said robotic industrial vehicle was stationary, classifying as external collision,
(ii) when said impact direction is consistent with said direction of commanded motion and no collision avoidance was active, classifying as self-caused collision, or
(iii) when said impact direction is consistent with said direction of commanded motion but collision avoidance was active, classifying as uncertain collision requiring offline analysis,
(e) computing collision severity metrics including peak acceleration magnitude and velocity change,
(f) classifying said collision into a severity category based on said severity metrics, and
(g) generating a collision event record including timestamp, position, vehicle state, IMU data, collision cause classification, and severity assessment; and
storing said collision event record.

11. The method of claim 10, further comprising:
upon detecting a collision event, triggering capture and storage of comprehensive multi-modal sensor data comprising:
(a) high-rate IMU data for a predetermined time window preceding said collision event and a predetermined time window following said collision event,
(b) LIDAR point cloud data for said predetermined time windows,
(c) camera image data for said predetermined time windows,
(d) audio data for said predetermined time windows, and
(e) robot state data including vehicle position, velocity, heading, control commands, and operational mode for said predetermined time windows;
wherein uncertain collision classifications are prioritized for immediate offline analysis using said comprehensive multi-modal sensor data to determine definitive causation, and wherein external and self-caused collision classifications are available for optional validation review.

12. The method of claim 10, further comprising:
aggregating collision event records over a time period for a fleet of robotic industrial vehicles;
generating spatial analysis by creating a collision heat map overlaying a warehouse floor plan with collision frequency data for each location;
identifying high-risk zones as locations where collision frequency exceeds a threshold;
generating temporal analysis identifying times of day, days of week, or operational conditions associated with elevated collision rates;
generating cause attribution analysis quantifying percentage distribution across three classification outcomes: self_caused collisions, external collisions, and uncertain collisions requiring offline multi-modal analysis, along with average confidence scores for each category;
generating recommendations for safety improvements based on at least one of: traffic routing changes to avoid high-risk zones, speed limit adjustments during high-risk times, increased spacing requirements in high-density areas, or operator training programs to address frequent external collision causes; and
presenting said analyses and recommendations to warehouse management personnel via a reporting interface;
thereby facilitating data-driven warehouse layout optimization, vehicle traffic management improvements, and targeted safety interventions in high-collision-frequency zones, resulting in measurable reduction in overall collision rates and associated costs.

13. The method of claim 10, wherein said computing collision severity metrics comprises:
determining one or more physical impact metrics from said filtered measurements over a collision event window, said physical impact metrics including at least:
(a) peak acceleration magnitude,
(b) velocity change magnitude, and
(c) impact duration;
computing a composite severity score based on a combination of said physical impact metrics, wherein said composite severity score emphasizes peak acceleration and velocity change; and
classifying said collision into severity categories based on comparing said composite severity score to threshold values, wherein said threshold values are determined through calibration.

14. A non-transitory computer-readable storage medium storing instructions that, when executed by one or more processors of a robotic industrial vehicle operating in a warehouse or industrial environment and equipped with an Inertial Measurement Unit (IMU), cause said one or more processors to perform operations for detecting and characterizing physical impacts when other vehicles strike said robotic industrial vehicle, said operations comprising:
receiving IMU data from said IMU comprising linear acceleration measurements and angular velocity measurements;
filtering said IMU data to attenuate noise while preserving collision signal characteristics;
detecting collision events by identifying anomalous acceleration patterns in said filtered IMU data that deviate from baseline operational characteristics;
for each detected collision event:
(a) determining an impact direction from said anomalous acceleration patterns,
(b) retrieving commanded navigation trajectory data indicating a direction of commanded motion at a time of collision,
(c) retrieving collision avoidance system state data indicating whether collision avoidance maneuvers were active at said time of collision,
(d) classifying collision cause into one of three categories based on relationships between said impact direction, said direction of commanded motion, and said collision avoidance system state, wherein external collision is classified when said impact direction is inconsistent with said direction of commanded motion or said robotic industrial vehicle was stationary, self-caused collision is classified when said impact direction is consistent with said direction of commanded motion and no collision avoidance was active, and uncertain collision is classified when said impact direction is consistent with said direction of commanded motion but collision avoidance was active,
(e) computing collision severity metrics including peak acceleration magnitude and velocity change,
(f) classifying said collision into a severity category, and
(g) logging comprehensive collision event data including timestamp, position, vehicle state, IMU data, classification results, and severity assessment; and
periodically analyzing logged collision events to generate safety insights and operational recommendations.

15. The non-transitory computer-readable storage medium of claim 14, wherein said operations further comprise:
integrating with a warehouse management system by:
(a) transmitting collision event summaries to said warehouse management system via a network interface,
(b) receiving operational context from said warehouse management system including traffic density, zone definitions, and vehicle scheduling information,
(c) contributing collision frequency data to warehouse safety dashboards and key performance indicators,
(d) triggering automated responses in said warehouse management system when collision frequency or severity exceeds thresholds, including traffic routing adjustments or safety protocol activations, and
(e) participating in fleet-wide collision analysis combining data from multiple robotic industrial vehicles to identify systematic safety issues.

16. A predictive collision risk assessment and mitigation system comprising:
a collision detection system providing historical collision event data organized by spatial location and temporal factors;
a risk modeling engine configured to:
(a) analyze historical collision frequency as a function of warehouse zone, time of day, traffic density, vehicle types operating, and environmental conditions,
(b) compute collision probability distributions for each warehouse zone during different operational periods,
(c) identify high-risk scenarios characterized by combinations of factors that historically correlate with elevated collision rates, and
(d) generate real-time collision risk scores for current vehicle operational context based on current location, time, traffic, and conditions;
a proactive intervention system configured to implement risk-reducing actions before collisions occur, said system comprising:
(i) a dynamic speed limit controller configured to reduce maximum vehicle velocity when predicted collision risk for current zone exceeds a first risk threshold, wherein speed reduction is proportional to risk level,
(ii) a traffic routing optimizer configured to modify vehicle path planning to avoid high-risk zones when predicted collision risk exceeds a second risk threshold higher than said first threshold,
(iii) an operator alert system configured to notify human supervisors or nearby human-operated vehicle operators to increase caution when predicted collision risk exceeds a third risk threshold, and
(iv) a traffic pattern adjustment module configured to implement one-way aisle restrictions or temporal access controls in persistently high-risk zones;
a risk validation module configured to monitor actual collision occurrences in zones where risk-based interventions were applied, comparing actual collision rates to predicted rates and updating risk models based on observed outcomes;
wherein overall collision frequency is reduced through predictive intervention before collision events occur, providing proactive rather than purely reactive safety management.
